(19) United States
(12) Patent Application Publication
(10) Pub. No.: US 2002/0090934 A1
(43) Pub. Date: Jul. 11, 2002

(54) Content and application delivery and management platform system and method

(76) Inventor: Eliott R.D. Mitchelmore, Chester (GB)

Correspondence Address: PILLSBURY WINTHROP, LLP, P.O. BOX 10500, MCLEAN, VA, 22102, US

(21) Appl. No.: 09/988,764

(22) Filed: Nov. 20, 2001

Related U.S. Application Data
(60) Provisional application No. 60/252,409, filed on Nov. 22, 2000.
(60) Provisional application No. 60/287,033, filed on Apr. 30, 2001.

(51) Int. Cl. H04M 11/10

(52) U.S. Cl. 455/412; 455/414; 455/466

(57) ABSTRACT

A system and method for delivering content, including, for example, dynamic data content and applications, to handheld devices, including, for example, web-enabled phones and personal data assistants, and other computer-related machines and for managing content on handheld devices and other computer-related machines.

The present application claims priority to U.S. provisional applications of Mitchelmore, Ser. No. 60/287,033, filed Apr. 30, 2001, and Ser. No. 60/252,409 filed Nov. 22, 2000, the entirety of which is hereby incorporated into the present application by reference.

### BACKGROUND OF THE INVENTION

1. Field of the Invention

The embodiments of the present invention are directed generally to a system and method for delivering data content and software applications (hereafter, referred to generally as “content” to, and managing that content on, Personal Digital Assistants (PDAs) and other computer-related machines.

2. Description of Related Art

Instant mobile information is already a reality. According to Dataquest™, 5.8 million PDAs were shipped in 1899. Indeed, Datamation forecasts that by the year 2005, there will be 270 million mobile subscribers, fully 70% of which will be capable of handling downloading, streaming, storing and interacting with data content and software applications. There are two main groups of mobile devices, also known as handheld devices: PDAs (where currently Palm OS® dominates) and web enabled phones (e.g., wireless mobile). PDAs include any small mobile hand-held device that provides computing and information storage and retrieval capabilities for personal or business use.

Various technology vendors are competing amongst themselves to define an ultimately successful platform for managing content downloaded for use with either or both of these two groups of handheld devices. Various services and products have been developed in the technology of PDA middleware. For example, the company 2roam™ offers on the fly reformatting of web content to be viewed on PDAs or phones. Similarly, Airflash™ offers location-based services for mobile phones.

AnyDay™ provides a web-based personal calendar system that can be synced to the Palm™ Datebook. Using the AnyDay™ system, additional data content available for downloading from the AnyDay™ web-site includes TV schedules, sports events, etc.; this data content can be added to an end user's online calendar provided on their PDA. However, only static content is available. Therefore, there is no way to continuously or repeatedly obtain dynamically changing content. Additionally, there is no way to add content to the end user's calendar without going to the AnyDay™ web-site. As a result, such a service requires that a data content or application provider be integrally involved with AnyDay™ to deliver its goods and services. Additionally, only calendar information is made available.

AnyDevice™ and EveryPath™ offer hosted software and services as licensed development platforms for creating new mobile applications and extending existing ones to encompass wireless devices. Some “off the shelf” vertical applications are available. However, there is no wired solution; only wireless “always-on” devices are supported. Additionally, the AnyDevice™ system involves a very complicated process for data content providers to deliver their goods and services to an end user.

AvantGo™ provides a service that delivers channels of web content to be viewed using an offline reader. However, the service is not personalized, inaccessible directly from a data content provider's web-site and has no provision for timely alerts to make an end user aware of new available content. Furthermore, only web content is delivered. There is no integration with the other functions on the PDA or integration with a Personal Information Manager (PIM), for example, MS Outlook.

Coola™ provides a mechanism to synchronize information to an end user's date book, address book or memo pad application by clicking on a Coolet™ button on a provider's web-page. However, content providers must enter data content via the Coola™ web-site or submitted dynamically when a content provider clicks on the Coolet™ button. Nevertheless, both methods for making data content available only provide an end user with a one-time download. There is no mechanism for updating content.

Palm Computing® provides HotSync™ server enterprise solutions for managing large numbers of Palm® devices and keeping them in sync with corporate data. Similarly, WeSync™ enables synchronization of groups of Palm® users via the WeSync™ web-site. Additionally, WeSync™ offers event listings that can also be synced to the end user's Palm®. However, available content is static and requires the end user to visit WeSync™ web-site to obtain it.

### SUMMARY OF THE INVENTION

At least one embodiment of the present invention is directed generally to a system and method for delivering content to handheld devices and other computer-related machines. At least one embodiment of the present invention is directed to a system and method for managing content on handheld devices and other computer-related machines.

In accordance with at least one embodiment of the invention, the content delivery and management system and method seamlessly translate online (e.g., wired) activities, be they Internet or intranet-based, onto wireless platforms—in particular handheld devices.

In accordance with at least one embodiment of the invention, the content delivery and management system and method alert an end user to view content, e.g., personalized to them, and link directly from that alert to the content through a note launching application.

At least one embodiment of the invention provides improved utility in that it allows end users to be alerted to the availability of new information in one or more formats they prefer and on whichever device(s) they are using.

In accordance with at least one embodiment of the invention, the content delivery and management system and method push entries into diaries, tasks and other applications of a handheld device, thereby providing immediate access to rich content by using frequently used interfaces/applications to alert user to new content by the end user.

In accordance with at least one embodiment of the invention, the content delivery and management system and method allow end users to select information from any Internet source that is relevant to their personalized needs.

At least one embodiment of the invention provides improved utility in that it allows originators of content and applications, e.g., data content providers, software developers, enterprises, customer service, etc. to implement content delivery and management in a more effective and efficient manner that reduces disruption of their ongoing business.

At least one embodiment of the invention provides improved utility in that it allows for an effective technique for content developers and providers to generate, monitor and manage revenue using embedded micro-payment and subscription functionality.

### BRIEF DESCRIPTION OF THE DRAWINGS

FIG. 1 illustrates content that may appear in a device 's PIM, e.g., a calendar;

FIG. 2 illustrates content that may appear in a device's PIM, e.g., an address book;

FIG. 3 illustrates an exemplary output of a Content management subsystem (CMS) in accordance with at least one embodiment of the invention;

FIG. 4 illustrates a subscription confirmation box displayed to a user in accordance with at least one embodiment of the invention;

FIG. 5 illustrates a subscription manager user interface configured to be displayed on an end user's personal computer (PC) including a list of subscribed to channels in accordance with at least one embodiment of the invention;

FIG. 6 illustrates interaction and cooperation of components of the content delivery and management system in accordance with at least one embodiment of the invention;

FIG. 7 illustrates interaction and cooperation of the content delivery and management system in accordance with at least one embodiment of the invention;

FIG. 8 illustrates a pop-up window providing details of the system plus the option for registration or subscription to a particular associated channel in accordance with at least one embodiment of the invention;

FIG. 9 illustrates a graphical user interface displayed to a user following acquisition of both subscribed channel data and an up-to-date list of all channels available from a content provider(s) in accordance with at least one embodiment of the invention;

FIG. 10 illustrates an integrated service that may be provided by systems and methods designed in accordance with at least one of the embodiments of the invention;

FIG. 11 is an explanatory illustration used to describe operation of a booking manager that may be used in the content delivery and management systems designed in accordance with at least one embodiment of the invention;

FIG. 12 illustrates an example of a confirmation e-mail;

FIG. 13 illustrates an example of a confirmation page;

FIG. 14 illustrates an example of confirmation dialogue interface;

FIG. 15 depicts one potential graphical illustration that may be displayed to the user during a booking manager update operation;

FIG. 16 depicts an example of a potential output of a handheld depicting itinerary details on a handheld device in accordance with at least one embodiment of the invention;

FIG. 17 depicts an example of a potential output of a Desktop PIM depicting itinerary details on a desktop PC in accordance with at least one embodiment of the invention;

FIG. 18 is an explanatory illustration of actions performed during operation of an application manager that may be used in the content delivery and management systems designed in accordance with at least one embodiment of the invention;

FIG. 19 illustrates an example of a confirmation e-mail;

FIG. 20 illustrates an example of a confirmation page;

FIG. 21 illustrates an example of confirmation dialogue interface;

FIG. 22 depicts one potential graphical illustration that may be displayed to the user during an application manager update operation;

FIG. 23 illustrates one representation of the features provided by at least a first embodiment of the invention;

FIG. 24 illustrates a block diagram depicting the structure and cooperation within a system designed in accordance with the first embodiment of the invention;

FIG. 25 illustrates one representation of the features provided by at least a second embodiment of the invention;

FIG. 26 illustrates a block diagram depicting the structure and cooperation within a system designed in accordance with the second embodiment of the invention;

FIG. 27 illustrates one representation of the features provided by at least a third embodiment of the invention;

FIG. 28 illustrates a block diagram depicting the structure and cooperation within a system designed in accordance with the third embodiment of the invention;

FIG. 29 illustrates one representation of functional architecture associated with at least the first embodiment of the invention;

FIG. 30 illustrates one representation of functional architecture associated with at least the second embodiment of the invention; and

FIG. 31 illustrates one representation of functional architecture associated with at least the third embodiment of the invention.

### DETAILED DESCRIPTION OF THE INVENTION

In accordance with at least one embodiment of the invention, a content delivery and management system and method enable enterprise systems to rapidly deliver information and applications over wireless or web-linked networks to handheld devices. Many organizations, from local authorities to international airlines, have invested resources into the development of web-based enterprise systems. These enterprise systems exist both as content rich intranets serving the needs of employees, and as Internet or electronic-commerce systems satisfying the needs of customers, suppliers, business partners and investors. One of the key challenges now facing such organizations is the deployment of these systems—not only to desktop users, but also to users of all mobile devices.

Content delivery and management systems and methods designed in accordance with at least one embodiment of the invention offer unique and timely opportunities to three distinct content oriented entities: content providers, customer service organizations and enterprises. Content providers may include, for example, originators of online information and entertainment—such as AOL®, Dow Jones®, Bertelsmann® and Yahoo®. Customer service organizations may include, for example, new economy and brick and mortar companies with a strong electronic-commerce focus, e.g., British Airways®, Expedia®, TicketMaster® and American Express®. Enterprises may include, for example, large and expanding organizations, increasingly reliant upon accurate and timely information for mobile and remote workforces—such as Cisco®, General Electric®, Accenture™ and Goldman Sachs®.

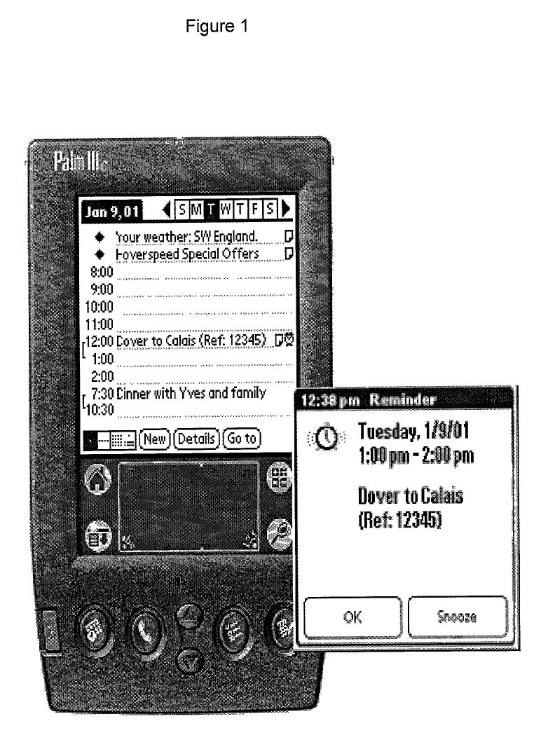

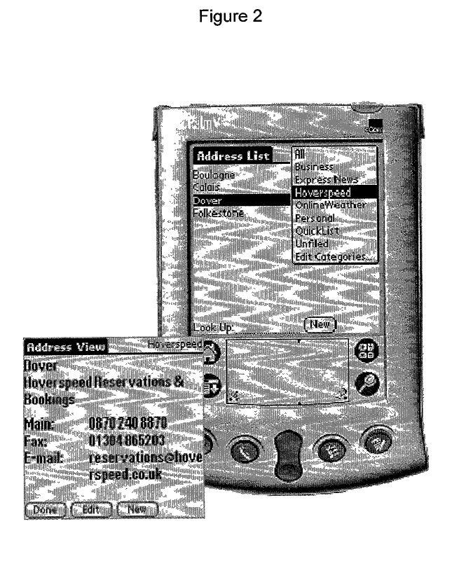

It should be appreciated that any of these three types of organizations may want to include, as part of their goods or services, the ability to download data content and/or applications (e.g., software packages), hereafter, referred to as “content”, to end users. As a result, the embodiments of the present invention are directed generally to a system and method for delivering content and managing that content on handheld devices and other computer-related machines. The content may appear, for example, in the device's most appropriate built-in PIM. For instance, chronological data, such as up-to-date weather forecasts may appear in the calendar (see FIG. 1), while travel company details and directions to hotels may appear in the address book (FIG. 2).

In addition to informational content, systems and methods designed in accordance with at least one embodiment of the invention are able to deliver and install applications via a one-click web system-specific icon interface.

Such systems and methods for content delivery and management may be of utility to customer service organizations where time specific events are relevant to end users—such as online ticket agencies or travel companies such as airlines or train operators. Any organization that wishes to provide their customers or employees with easy access to information such as corporate contacts, retail outlets, support numbers, etc., may find utility in the present invention. Such information can be made available via the Internet or company intranet and inserted directly into the end user's address book in a custom category. During the initial setup of channels for delivery of PIM data, the content provider can specify the name of a category to be created on the end-user's device to hold the channel content.

Additionally, utility may also be provided to companies wishing to perform controlled roll out of applications and databases to handheld device users, including in-house Information Technology (IT) departments (for example during rollout of new versions of sales software to fields sales staff) and software archives such as ZDNet™, PalmGear™ and Handango™.

In accordance with at least one embodiment of the invention, content delivery and management systems may provide seamless distribution/installation of software applications, thereby adding functionality to employees and managers of enterprises. For example, specific applications may be developed to create vertical solutions that have strong appeal to organizations within a particular sector, for example, personalized TV guides, adult entertainment, ticketing customer service, online gaming, electronic books and publications, news-feed services, music download and replay, television previews and scheduling, recruitment and contracting, listings and entertainment, betting and gambling, personal investment portfolios, entertainment previews, etc.

In accordance with at least one embodiment of the invention, content delivery and management systems may provide outsourced solutions to end users and content providers—where software, solutions, data-management, hosting, bandwidth, support and related services are contracted for through an administrator associated with the content delivery and management system.

At least one embodiment of the invention is built on of be compatible with standardized technologies, e.g., server-based technology may include Hypertext Transfer Protocol (HTTP) Secure Sockets Layer (SSL), (JDBC), HyperText Markup Language (HTML), Javascript; Client—HotSync(Palm's proprietary solution for synchronizing data between a Palm OS device and a desktop computer), ActiveSync™ (Microsoft's® proprietary solution for synchronizing data between a PocketPC device and a desktop computer), Palm™ Quality Application (PQA), Internet Explorer™.

At least one embodiment of the invention also offers a simple interface to both the end user and the content provider's backend systems. For the end user, the interface may be the system-specific icon on a web page and the intuitive functionality of the subscription manager explained herein. For the content provider, the interface may be the visual mapping of data fields in their data source to available fields in the PIM or web templates, the emulation of the resulting channel content and the automatic generation of the appropriate HTML for their HandChannel enabled web pages.

A content provider who wishes to enable delivery of content from their web-site needs to perform four distinct tasks: creating channels, formatting content, publishing content and installation of a content delivery and management system icon. A content delivery and management system administrator may provide assistance for each of these tasks.

Creating Channels

A channel is a mechanism for delivery of content to an end user. A channel provides one specific piece of content within a service. This content may be, for example, an application file, a collection of compressed application files along with configuration settings or it may be promotional messages. Channels may be set-up and maintained via a system Content Management Subsystem (CMS) which may be a web-based application that may reside on one or more servers associated with the system or on the content provider 's server. A channel may be needed for each specific piece of data that the content provider (used herein to include application developers and/or distributors as well) wishes to make available via the content delivery and management system. For instance, a channel could be “London four day weather forecast” or “Latest financial news” or “Acme office locations”.

A channel represents one specific/focused/targeted/personalized piece of content formatted for delivery to one specific application on the device. A channel may carry calendar entries, address book entries, a collection of web pages and images, an application, a database etc. Each channel's content may be formatted and encoded for the requesting device. It is the smallest piece of content that a user may subscribe to or unsubscribe from. Each channel has a number of attributes that help describe it to the user, control its updating, and determine where on the target device it will be delivered in addition to how and from where the content will be generated.

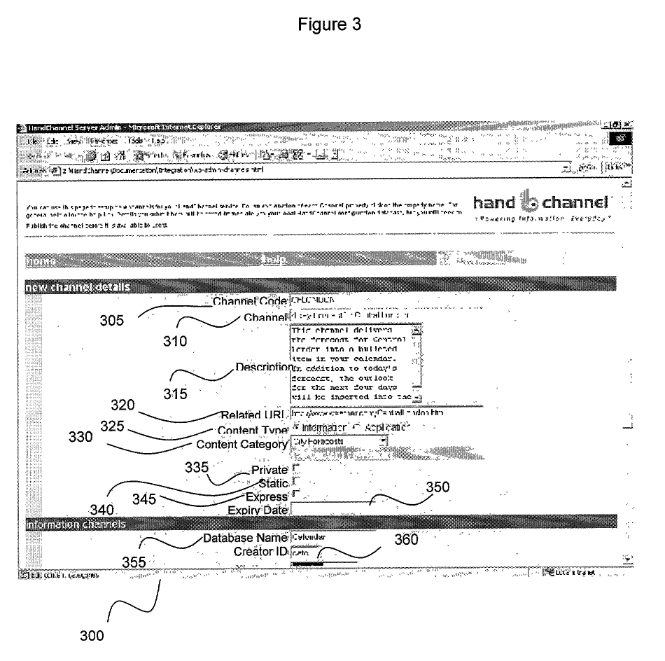

FIG. 3 illustrates one implementation of an interface provided as part of the system used by content providers to build new channels. As shown in FIG. 3, the interface may be, for example, a Graphical User Interface (GUI) 300 that includes various fields for data entry. For example, the GUI 300 may include various data fields associated with new channel details such as, for example, a channel code field 305, a channel name field 310, a description field 315, a related Universal Resource Locator (URL) field 320, a content type field 325, content category field 330, an indication if the content is private in a privacy indicator field 335, an indication if the content is static, as opposed to dynamic, in a static indicator field 340, an indication if the content expires in an expires indicator field 345 and an indication of an expiration date associated with the content in an expiry date field 350. This information for each of the channels may be stored in the CMS configuration database hosted on one or more servers associated with the system.

The channel code field 305 may contain a channel code, which may uniquely associates a channel within a service. A service is a collection of channels and usually associated with a particular web site or other on-line software source, e.g., PalmGear™. A service will usually be one content provider but sometimes a content provider may provide many services if they have a diverse set of content. The channel code may be chosen by the content provider and may relate to or indicate the content as it currently exists on their web site. For instance, on OnlineWeather's site the dynamically generated regional weather for Greater London may be identified by RFENGL. The channel code may also be a customer or order number. The channel code may be some type of unique identifier that may assist the content provider reference the channel.

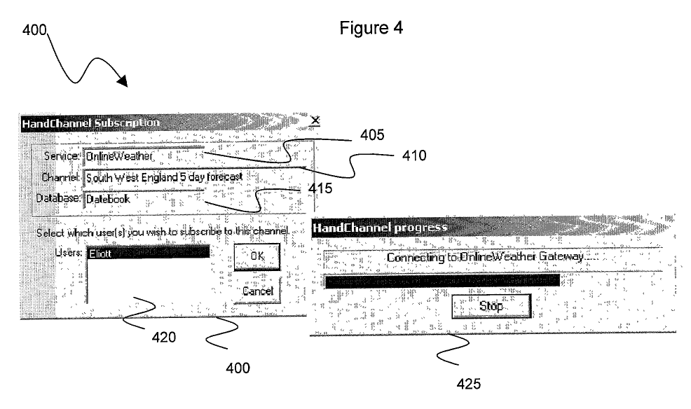

The channel name field 310 may include a channel name that may briefly describe the channel content, for example, the “South West England 5 day forecast”. This channel name may be displayed in a subscription confirmation box displayed to the user after clicking on the system icon on a content provider's web-page as shown in FIG. 4. Thus, the system icon (described in greater detail below) may be used to begin interaction with the content delivery and management system.

For example, as shown in FIG. 4, a subscription confirmation box 400 may be displayed to a user on a GUI generated at least in part by the system. This subscription confirmation box 400 may list an associated service (in service field 405), channel (in channel field 410) and PIM associated with the subscribed to channel (indicated in a database field 415). The subscription confirmation box 400 may also provide a field 420 that lists options as to which users are to be subscribed to the channel. Such a field 420 may be of utility for allowing access to enterprise information to a group of users syncing to one desktop computer. The progress dialog may be only displayed during an update/syncing process and may not be displayed during confirmation of subscription; thus, the subscription dialog may not be displayed at the same time as the progress dialog.

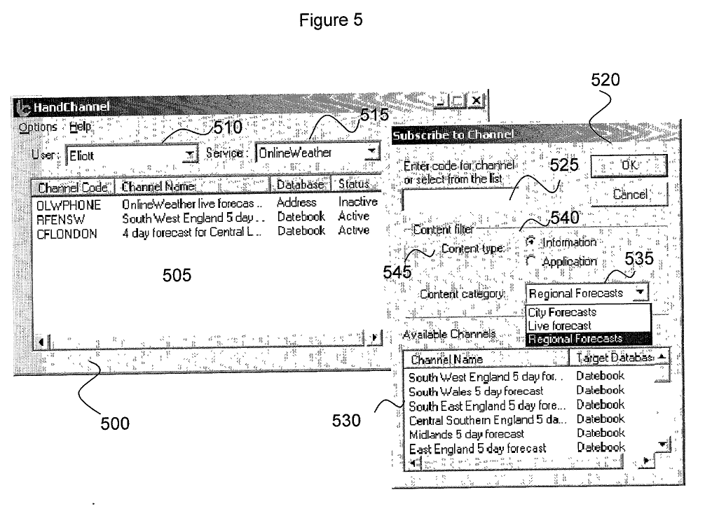

The channel name may also be displayed in a subscription manager (explained below) on the user's PC in a list of subscribed to channels. For example, as shown in FIG. 5, a GUI 500 at least partially generated by the system may include a list 505 of all the channels that a user (indicated in a user field 510) has subscribed to provided by a service (indicated in service field 515). This list 505 may also include the PIM associated with a subscribed to channel (indicated as the associated database) and its status. The GUI 500 may also include a section 520 associated with subscribing to additional channels. The section 520 may include, for example, a field 525 where a user may enter a code associated with a particular channel to add that channel to their subscription. Alternatively, or in addition, the section 520 may include a list of channels 530associated with the service identified at 515 from which a user may select. This list of channels may be organized by content category. Therefore, a user may view a list of channels that are associated with different categories within the service, for example, city forecasts, regional forecasts, live forecasts, etc.

By selecting on a content category selection field 535, the user can select from the constituent categories within the service. This capability may be included in a content filter 540. The content filter may be functionality of the dialog box in the subscription manager on the user's PC or device. It may allow the user to quickly drill down to the content they are looking for from a service that may offer many hundreds of channels instead of scrolling through a long list. Further, the user can filter data content from application content using a content type filter field 545.

Returning to the description of the subject matter illustrated in FIG. 3, the description field 315 may include more detailed information about the channel and its content if required. For example, a channel description may be up to 4096 characters in length. An example may be “This channel delivers the latest weather forecast for London into your calendar. It provides a four day rolling window which is updated each time you HotSync®. For instance, when you perform a HotSync® on Monday you would get . . . ”.

The related URL field 320 may display one or more URLs that the user may find out additional information about the channel. It could be the URL of the page that the user first subscribed from, it could be a general system-specific information page provided by a content provider, etc. The related URLs may be accessed through the subscription manager's subscription properties dialog. The related URL field 320 may include information associated with a channel associated with a content location URL of pre-formatted channel content. This may be a location where client software may send a request for channel content. For channels using an automated formatting through a system packet engine (explained below), this may be the URL of the engine gateway script. For channels where the content is pre-formatted, e.g., applications, this URL may be a URL where the content file can be downloaded from, e.g., www.onlineweather.com/channels/london.dat.

The content type field 325, may identify the type of content provided by or accessible through the channel, e.g., information, application, etc. Information content may be integrated into one of the PIM applications on the device. Application content may be installed as an additional autonomous software or data component. The content category is a category defined by the content provider to group channels with similar content.

The database category 355 may identify the category to be created on the user's device to hold PIM data. This data may be stored in a CMS configuration database resident on one or more servers associated with the system. For example, each channel may have a database category, which may be a category on the user's handheld or device that may store the channel content, e.g., date book (FIG. 1), address book (FIG. 2), etc. Each channel may also be associated with a particular data format. The channel content can be made available in, for example, target device specific binary format, Comma Separated Value (CSV) or a custom format. CSV may be sufficient and may be used as a default.

The content category field 330 may include information about the content associated with the channel. Channels may be divided into content categories to allow the user to find channels that interest them quickly in the subscription manager, e.g., regional forecasts (see FIG. 5).

The privacy indicator field 335 may include an indication of whether the channel is private, in which case a user may need to provide a username and password to access the channel content.

Additionally, each channel may be identified as secure using a flag. If this flag is set, the user software may use secure hyptertext transfer protocol to retrieve the channel content.

The static indicator field 340 may indicate the degree of change in a channel's content. For example, a channel may be identified as being static using a flag. If a channel is flagged as static, then its content may only be downloadable to the user once. The subscription will then be de-activated but will still show in the subscription manager. Static channels may be used to deliver relatively static data, e.g., office locations. The content delivery and management system may allow the user the option to check for updates in the future if required.

The expires indicator field 345 may indicate whether the content provided by the channel expires. If the channel does expire then a date is given for the expiry date field.

The expiry date field 350 may indicate an expiration date or time associated with the content provided on a channel or the channel itself. Thus, a channel may have limited life. This capability of limiting access to data may be used for channel content associated with a purchase, e.g., ticket booking, download of commercial software. If a flag is set that indicates an expiration date, then the channel may be automatically removed from the content delivery and management system server or inaccessible via that server when the expiration date or time is reached. An example of such a channel may be for a travel itinerary that may only be available until the day after the first day of travel or can be set to remain in the datebook.

The content may be stored on the content provider's systems and may be only stored temporarily on the one or more servers associated with the system during formatting, encoding and compression by the packet engine. When a channel expires the channel may be deleted from the configuration database and so be inaccessible by the user.

Each channel may be associated with a support group, which may be a group of channels that supply supporting content. Although only one type of content may be delivered through one channel, a content provider may have the ability to create channel support groups. Support groups may be one or more channels to which an end user is subscribed automatically when subscribing to one other main channel. For instance, if the main channel delivers the five day forecast for a city into the user's calendar then a support channel may be used to transfer a live forecast telephone number into the address book. If the main channel inserts a travel itinerary into the user's calendar then a support channel may be utilized to add hotel information to the address book. If the main channel was used to deliver notification of the release of the latest sales figures through a bulleted item in the diary, then support channels for delivering a sales spreadsheet and viewing application could be used. Support channels for a number of standard applications may be available if required, e.g., image viewing, video playback, HotSync® reminders, database viewing, etc.

Additionally the GUI 300 may include data fields associated with information channels including a database name field 355 and a creator identification field 360. The database name field 355 indicates may be a descriptive name chosen by the content provider for the type of content being delivered, e.g., Datebook, Calendar, Diary, Contacts, Address Book, Images, Application, Game, Database, Spreadsheet, etc. The creator identification field 360 indicates the creator of the channel for the purposes of administration and maintenance. This field may or may not be shown to the content provider. The creator identifications included in this field may be a unique identification code registered through a third party to identify an application and associated data on the device.

In addition to text-based content channels, the content delivery and management system can be configured to also deliver programs and databases through application-type content channels using, for example, an application manager. For most application-type content, the channel details will remain static. For some application-type content, however, e.g., ticketing, the channels may be created dynamically, or on the fly, and may have a limited life, e.g., the booking manager, explained below. Channel details for all types of content may generally remain static, something like ticketing being the exception or any channel associated with a purchase, e.g., commercial software download.

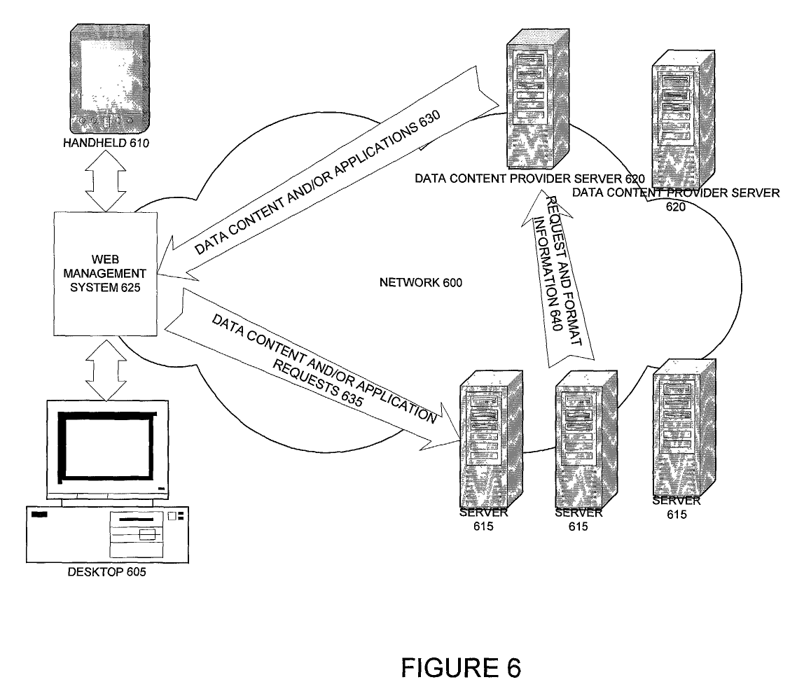

FIG. 6 illustrates interaction and cooperation of components of the content delivery and management system in accordance with at least one embodiment of the invention. As shown in FIG. 6, content 630 are provided by the content provider server(s) 620 over the network 600 in response to request(s) 635 received by the content delivery and management server(s) 615 from the end user via the web management subsystem 625. The network 600 may be any public and/or private network, e.g., the Internet. This web management subsystem 625 receives user input/output via the desktop 605 and/or the handheld device 610. The web management subsystem 625 coordinates receipt of the requested content 630 from the content provider 620 over the network 600. The web management subsystem 625 also formulates the content requests 635 based on information received from the end user via the desktop 605 and the handheld device 610. The web management subsystem 625 also sends the content requests 635 over the network 600 to the content delivery and management system server(s) 615. This content request data 635 is analyzed at the content delivery and management system server(s) 615. Request and formatting information 640 is subsequently sent from the server(s) 615 to the content provider server(s). This interaction between the content provider server(s) 620, the web management subsystem 625 and the content delivery and management server(s) 615 allows the user to receive data directly from the content provided in a format he/she has requested for his/her particular device(s) or via one or more servers associated with the system.

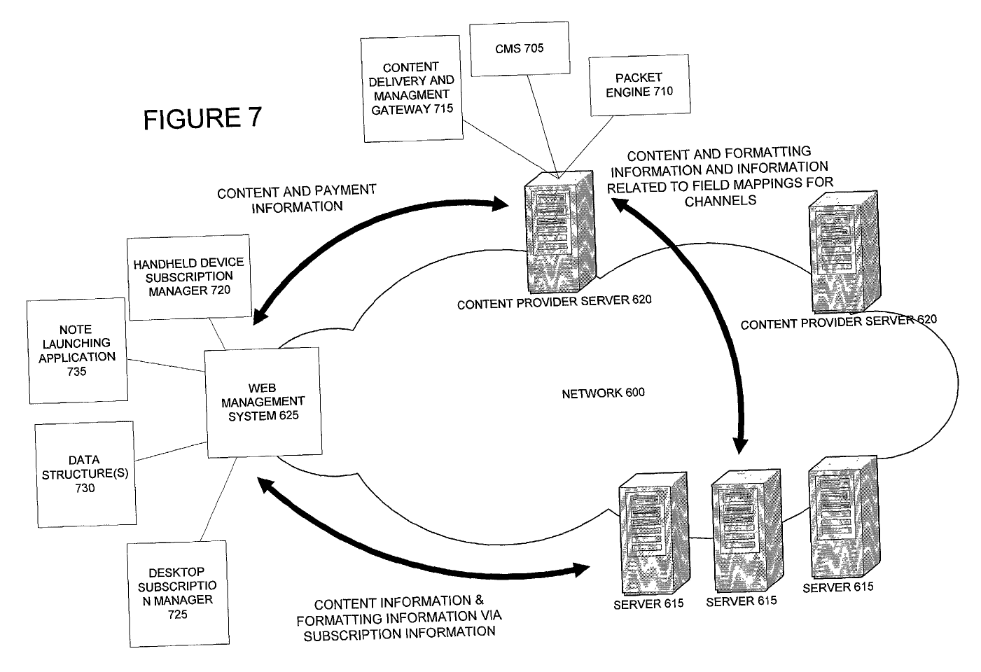

As shown in FIG. 7, the content provider servers 620 may include the CMS application 705, one or more packet engines 710, content delivery and management gateway 715. The functionality associated with these components may be supported by or implemented via one or more servers associated with the system. No component may be necessary on the content provider's server except in the case of an enterprise user requiring their own installation of the entire system. The components on the server are the CMS (for setting up channels, mapping data to templates etc.), the packet engine (including a packet formatter and a packet compressor) and a user gateway (being associated with registration, authentication, channel directories).

The CMS 705 may also provide templates for mapping data fields and rich content—enabling designers and programmers at the content providers through an ‘out of the box’ solution, to format content for the smaller screen sizes of handheld devices.

Also shown in FIG. 7, the one or more packet engines 710 may format and compress text, images and graphics into an information package, i.e., a channel packet that may then be sent to an end user's device via either wireless or wireline transmission for viewing on the devices embedded browser or built in PIM applications.

A content delivery and management system designed in accordance with at least one embodiment of the invention may encompass future ‘always on’ wireless infrastructure, e.g., General Packet Radio Service (GPRS) and 3G and emerging industry standards for data synchronization using Synchronized Markup Language (SyncML).

There are three main processes that form part of the content delivery and management system: formatting data, installation of system icons, and user registration.

Formatting Data

For information channels, a content provider needs to format their data for delivery through the content delivery and management system. This may be achieved by the content provider's personnel using the CMS by locating and connecting to an Open DataBase Connectivity (ODBC) data source of the content provider, e.g., supported by the servers 615 supporting the delivery and management system, and mapping the available data fields to appropriate placeholders in templates. There are templates for PIM data in addition to a choice of different templates for web content. This activity must be completed for each channel. These placeholders may vary depending on the type of data that the channel is delivering.

Once the field mappings have been set-up, the system packet engine(s) 710 may dynamically format data from the content provider's data source as channel data is requested by the client software included in the web management subsystem 625 running on the end user's PC and/or handheld. Tables show the format for memo (Table 1), calendar (Table 2) and contacts (Table 3) packets. Specific examples relevant to a particular content provider's data have been supplied to illustrate the best use of the data structure.

It should be understood that, in accordance with at least one embodiment, the system may handle all functionality associated with the system internally for content providers. However, if some portion of that functionality is provided by hardware and software resident with the content providers, publishing content may be a necessary intermediary step in-between formatting data and installation of system icons. In such a configuration, once the field mappings have been completed the content provider may publish the channels they have set up to the content delivery and management gateway 715. This may be achieved using the CMS 705. Once this is done, the channel content may be accessible to end users via the content provider's web server. This access may be protected with authentication procedures (private channels) and/or residence of the content and associated mappings on a secure server. It should be understood that the content provider only uses the server(s) supporting the delivery and management system as a directory for published content, none of the content provider 's actual data is required to be stored permanently to support service.

Installation of System Icon

A HTML code snippet may be embedded in each page and/or area associated with each channel that displays the content delivery and management icon, and links to the server(s) supporting the content delivery and management system 615 providing the associated service and channel identification. For example, for dynamic channels, e.g., those whose content is updated regularly, such an HTML snippet may be:

<!—HandChannel code start. Please do not alter any part of this code without prior permission -->
<a href=“http://sync.handchannel.com/noscript.htm”
onClick=“window.open(‘http://sync.handchannel.com/scripts/HcGateway.dll?PreSubscribe?SID=[Service
ID ]&ChannelCode=[Unique Channel Code ]‘,‘HandChannel‘,‘width=250,height=375‘);return false”
onMouseOver=”window.status=‘Get this information everyday with HandChannel‘;return true”
onMouseOut=”window.status=‘‘;return true”><img
src=”http://www.handchannel.com/images/EverydayButton.gif”border=”O”></a>
<!—HandChannel code end -->

Alternatively, for a static text-based and application-type channels (e.g., one-time downloads), the HTML snippet may be:

<!--HandChannel code start. Please do not alter any part of this code without prior permission -->
<a href=“http ://sync.handchannel.com/noscript.htm”
onClick=“window.open(‘http://sync.handchannel.com/scripts/HcGateway.dll?PreSubscribe?SID=[Servic
e ID ]&ChannelCode=[Unique Channel Code ]‘,‘HandChannel‘,‘width=250,height=375‘);return false”
onMouseOver=“window.status=‘Get this information now with HandChannel‘;return true”
onMouseOut=“window.status=”;return true”><img
src=“http://www.handchannel.com/images/NowButton.gif“border=“O”></a>
<!--HandChannel code end -->

After completion of these tasks the system is enable to deliver and manage the published content. As a result, there may be no further need for action or maintenance on the content provider's part or the published content.

FIG. 7 shows one implementation of the web management subsystem 625 illustrated in FIG. 6. The web management subsystem 625 may include a mobile device subscription manager 720, and a desktop subscription manager 725, which may include device-based technology (for the wireless environment) and PC-based technology for the (wireline environment), respectively, that allow the end user to manage the content they are receiving. The system 625 may also include one or more data structures 730 configured to store user-specific data.

The subscription manager may be implemented as an application that enables a user to keep track of current channel subscriptions and allow them to view a list of all channels available from services in which they are interested. The subscription manager may be implemented using or compatible with various technologies including, Microsoft® Foundation Class (MFC), Wininet, HTTP, SSL, etc. A synchronization agent, e.g., a conduit or similar mechanism may be used to synchronize subscription manager configuration information with handheld devices in addition to invoking the subscription manager update process during a HotSync®/ActiveSync® and transferring notification messages to the device calendar. The user's personal configuration on the handheld device may need to be mirrored on the desktop and vice versa. Synchronization may also need to take place across multiple desktop computers should the user wish to attach their device to multiple PCs, e.g., home and work. The synchronization agent may be implemented using or compatible with various technologies, e.g., Palm® CDK, MFC, etc.

The web management subsystem 625 may also include a note launching application 735 that may include unique technology for Palm OS® devices that enable a specific application (normally the embedded browser) to be launched from a note icon that may be attached to a diary or to-do list entry that may be associated with an alert that may be placed in a user's diary as a prompt to view content (placed there by a content provider). An alert to an end user of time critical events (or e.g., daily messages) may take the form of either a timed or un-timed diary entry—with or without an alarm, auto e-mail, Short Message Service (SMS) message or personalized ring tone.

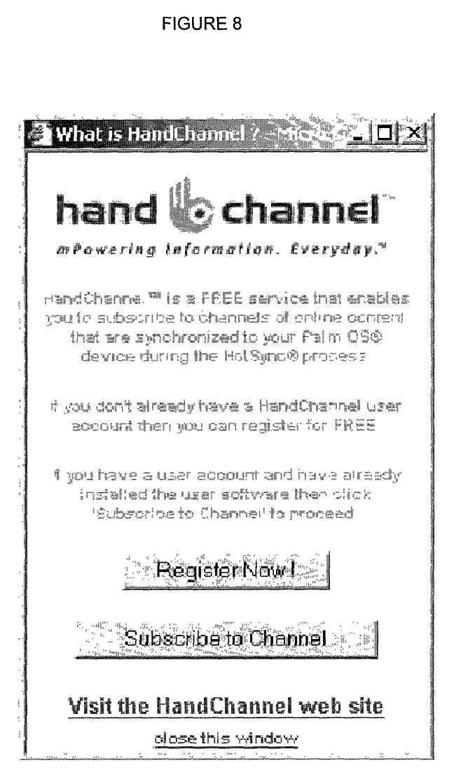

Prior to a user being able to access and utilize the content provided via the content management and delivery system, the user must register with the system. This may be done by, for example, a user accessing the system for the first time by clicking on one of the system icons embedded in a content provider's web-site, the user accessing a web-site associated with the content delivery and management system. When an end user clicks on the content delivery and management system icon on an enabled web-page, a window may pop-up (see, for example, FIG. 8) giving brief details of the system plus the option for a one-time registration or to subscribe to a particular associated channel. When the end user chooses the one-time registration option they are led through a series of pages, one of which prompts them to enter personal details, e.g., name, e-mail, etc., and some indication of acceptance of terms and conditions of system use.

After entering these details, the user may be immediately e-mailed an activation code for downloading the user software to be included in the web management subsystem 625. This code along with the user's e-mail address may be used to track the user's use of the services provided by the delivery and management system. After entering the registration details the user may be e-mailed an activation code for the content, e.g., an application. If the content is an application, at the same time, an install page may be displayed to the user where the user may install directly from the web or download a complete application package for later installation. The activation code may be required when the user first activates the software, usually by subscribing to a channel.

To use the systems and methods of content delivery and management, an end user may install a content delivery and management software package on their desktop computer through a simple online process. This online process may ascertain what devices and software the user is operating with on both their handheld devices (e.g., PDAs and mobile phones) and desktop devices. The end user may then be taken to a page where the end user may install the user software directly from the Internet or download a complete installation package to launch the web management subsystem 625. Installing this software directly can drastically reduce the size of the download by determining those files that are actually required on the user's specific devices. However, should the user wish to install later or install on a different piece of equipment then they have the option to download the full package. This whole process may take place without the end user leaving the content provider's site. Installing the application package from web may be quicker and simpler; downloading may require decompressing a large compressed file.

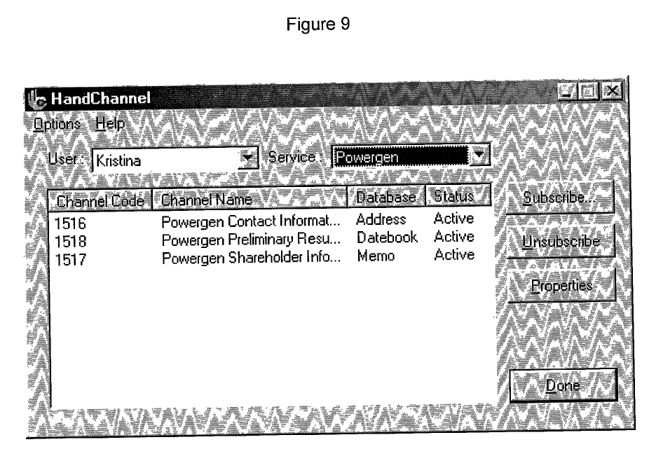

FIG. 9 illustrates a graphical user interface displayed to a user following acquisition of both subscribed channel data and an up-to-date list of all channels available from a content provider(s) in accordance with at least one embodiment of the invention.

In accordance with at least one embodiment of the invention, delivery of actual content to the end user may take place during linking between a handheld device and a more substantial notebook, desktop or other computer, for example, during a HotSync®/ActiveSync® process for a Palm OS handheld computer. Such a link may be provided via a cable, or using a wireless connection. If the portable computer and the larger machine are in the same room, the link can use infrared radiation. Therefore, systems and methods designed in accordance with that embodiment are tightly integrated with the user's routine usage of their handheld devices.

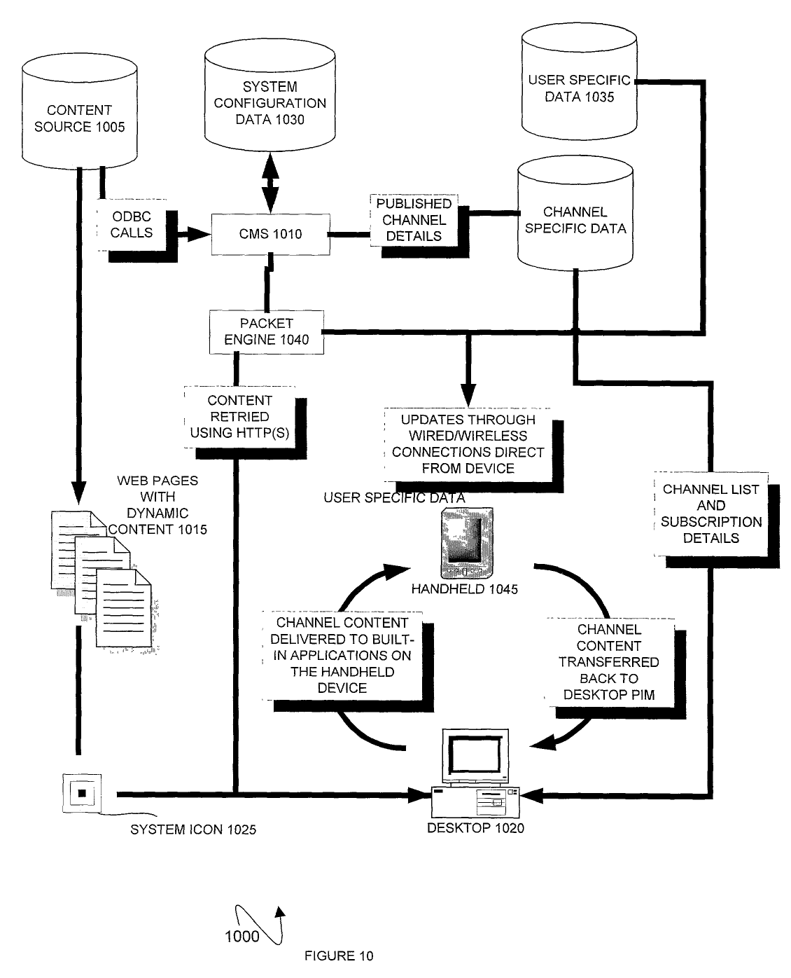

FIG. 10 is an exemplary illustration of integrated service functionality that may be provided by systems and methods designed in accordance with at least one of the embodiments of the invention. As shown in FIG. 10, a content source 1005, for example, a content provider provides Open DataBase Calls (ODBC) to the content management subsystem (CMS) 1010. The content source 1005 also provides access to web-pages with dynamic content 1015 via the desktop 1020, which are accessible using a web-browser (not shown in FIG. 10). These web-pages 1015 may include one or more system-specific icons 1025 associated with the content delivery and management system 1000. This icon(s) 1025 may be accompanied by a link to web-pages associated with the delivery and management system 1000 described herein.

System configuration data 1030 is provided to and accessed by the CMS 1010—based on requests from the CMS 1010. The CMS 1010 sets up channels and formats data from the data source of the content provider. In turn, the CMS 1010 provides details about published channels to a channel specific database 1035. The CMS 1010 provides the formatted data from the data source 1005 to the packet engine 1040, which dynamically formats and compresses content associated with particular channels. The packet engine 1040 provides updates to the handheld device 1045 via wired and/or wireless connections direct from the handheld.

Once software associated with the web management subsystem is installed on the end user's devices (e.g., the desktop 1020 and the handheld 1045, the end user may subscribe to an available channel by clicking on the system icon 1025 (on an enabled web-page). This system-specific icon may be linked to a small subscription file, which includes all the information the web management subsystem requires to connect to the associated channel. The subscription file type may be setup during installation so it is downloaded and opened in one action (see FIG. 4). During the next HotSync®/ActiveSync®, the user software fetches both the subscribed channel data and an up-to-date list of all channels available from the content provider (FIG. 10). The user then may subscribe to further channels direct from the subscription manager without having to visit the associated web-page. The subscription manager also gives the end user the opportunity to deactivate or remove subscriptions (FIG. 10).

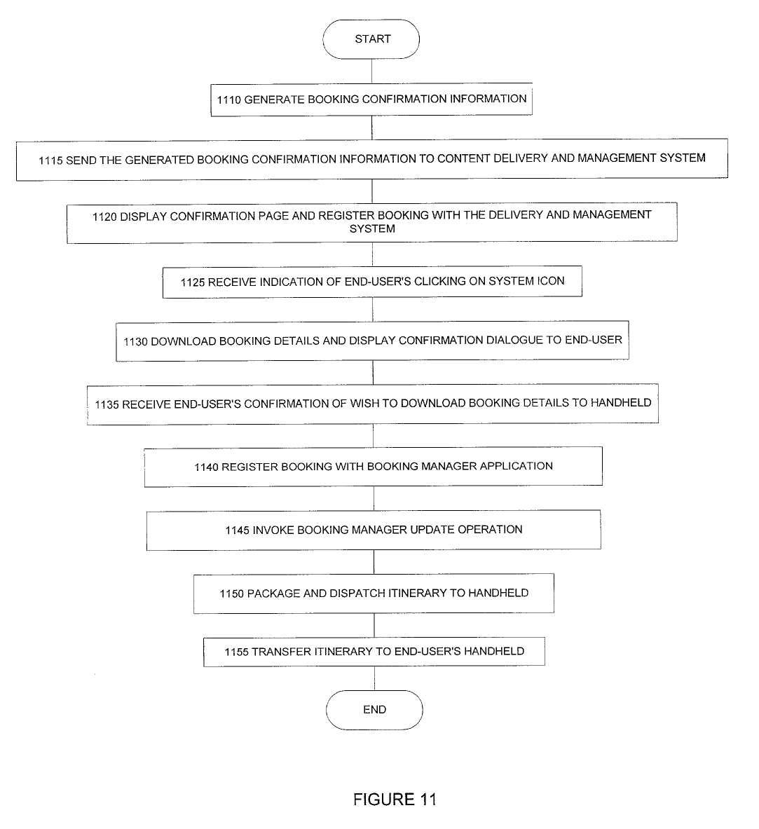

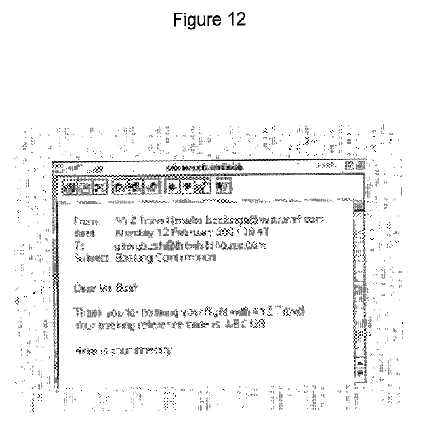

An explanation will now be provided of one example of operation of a booking manager that may be used in the content delivery and management systems designed in accordance with the invention. As shown in FIG. 11, at 1110, an e-commerce system may generate booking confirmation information after an end user has made an on-line purchase using the e-commerce system. Control then proceeds to 1115, at which the information is sent to the content delivery and management system server(s) via, for example, an ASP/PHP interface, or alternatively a booking confirmation e-mail, e.g., the e-mail illustrated in FIG. 12, that can be duplicated and sent to the system server where the information can be extracted whilst the original e-mail is forwarded to the end user.

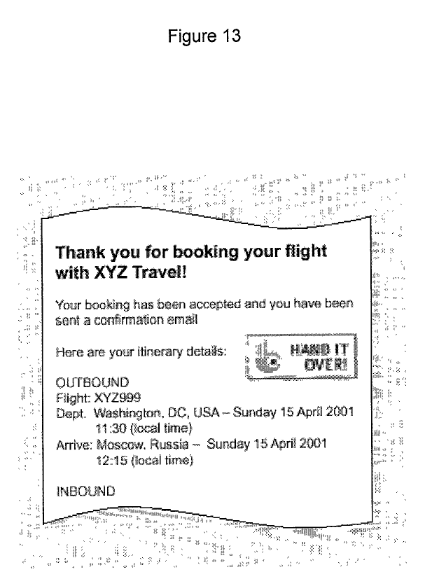

At 1120, a confirmation page (e.g., the confirmation page illustrated in FIG. 13) may be displayed to end users in their browser and the booking may then be registered with the content delivery and management system server(s). The confirmation page may display the system icon with the booking ID as a hidden parameter. The end user's details (e.g., name, country and e-mail) may be extracted from the confirmation details; if the end user is not an existing content delivery and management system user, these details may be presented during the registration process. Once the end user is registered, their authentication details may be associated with the channel used to deliver the booking itinerary so that only they may access it from the system server.

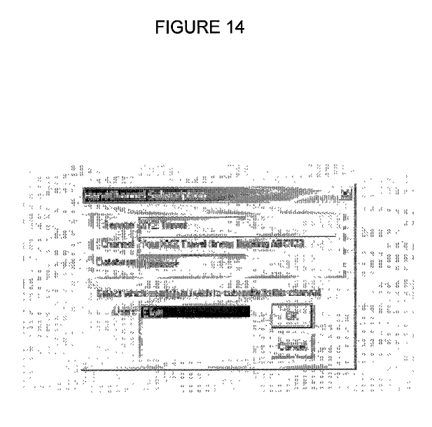

Subsequently, at 1125, an end user may click on the system icon displayed on the confirmation page. Control then proceeds to 1130, at which the system's booking manager may then download booking details and display confirmation dialogue (e.g., as illustrated in FIG. 14) to the end user. Once the system receives an end user's confirmation that they wish to download the booking details to their handheld at 1135, the booking is registered with the booking manager application 1140.

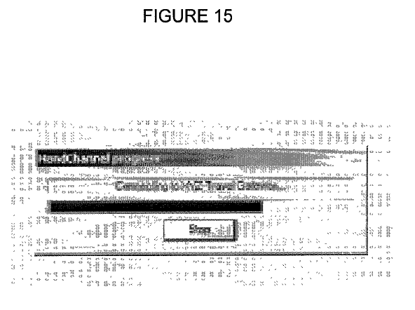

At 1145, a booking manager update operation may be invoked either directly by the end user or through the HotSync®/ActiveSync® process (see FIG. 15 depicting one potential graphical illustration that may be displayed to the user during this update operation). During an update, the end user's identity may be authenticated and the booking details may be requested.

Subsequently, at 1150, an itinerary is packaged and dispatched to the hand held. The end user's itinerary details may be retrieved from a content delivery and management server cache and packaged for delivery to the handheld device. Once the booking manager receives this package, the relevant details may be integrated into the end user's handheld device calendar.

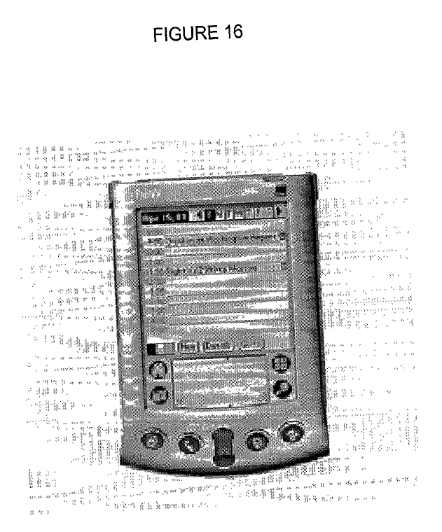

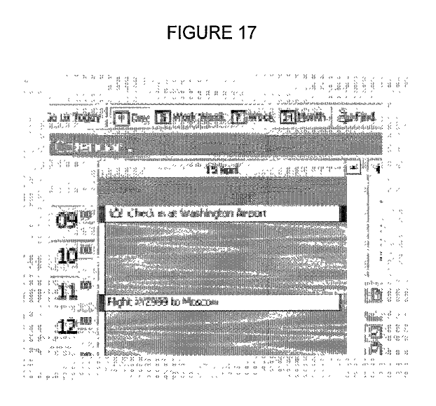

At 1155, the itinerary is transferred to the desktop. During the normal HotSync®/ActiveSync® process, the itinerary information may be transferred from the handheld to the desktop PIM if the end user's desktop synchronization software is set to do so. FIGS. 16 and 17 depict examples of potential outputs of a handheld depicting the itinerary details on a handheld.

It should be appreciated that, channel details may be purged if necessary. For example, the channel associated with the booking can be set to expire after a certain time e.g., one month after ticket date, or can be held for an extended period for customer reference.

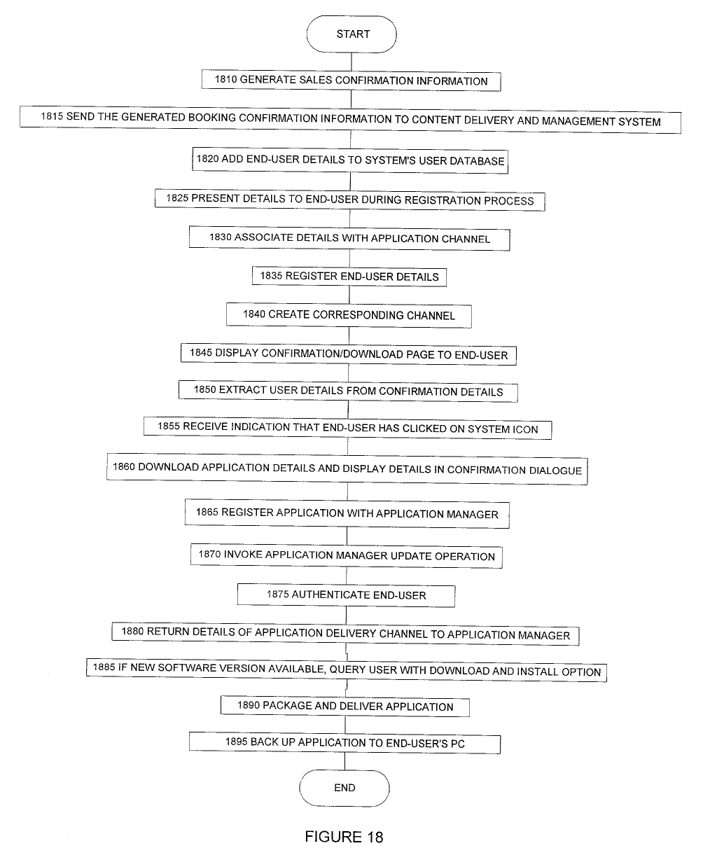

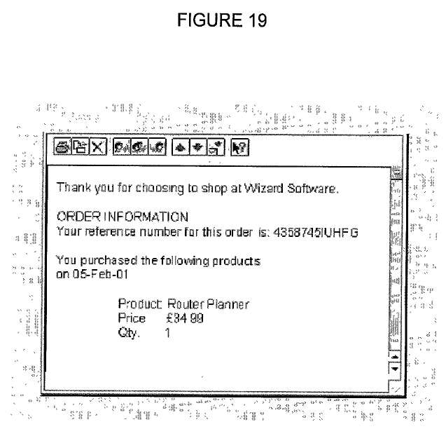

An explanation will now be provided of one example of operation of an application manager that may be used in the content delivery and management systems designed in accordance with the invention. As shown in FIG. 18, at 1810, an e-commerce system may generate sales confirmation information after a purchase is made by an end user on-line. Subsequently at 1815, the required details (e.g., customer name, email address, order confirmation code, etc.) may either be posted directly to the content delivery and management system server or can be extracted from a normal confirmation email (an example of which is shown in FIG. 19).

At 1820, the end user details are added to the system's user database. These details may then be represented to the end user during a one-time registration process at 1825 and then associated with the application-type content channel used to deliver the commercial software package at 1830 so that only the end user can access it.

Application details may then be registered at 1835 and the corresponding channel may be created at 1840. Information about the application (e.g., software package), for example, name, description, version information, may be used to create the application-type channel. For commercial software, this channel may be linked to one specific user.

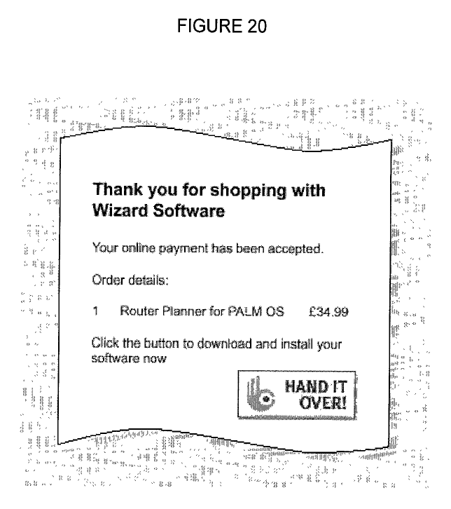

A confirmation/download page (an example of which is shown in FIG. 20) may then be displayed to the end user in their browser at 1845. The page may display the system icon with the channel ID as a hidden parameter. User details (e.g., name, country and email) may be extracted from the confirmation details at 1850 and, if the end user is not an existing system user, these details may be used during the registration process.

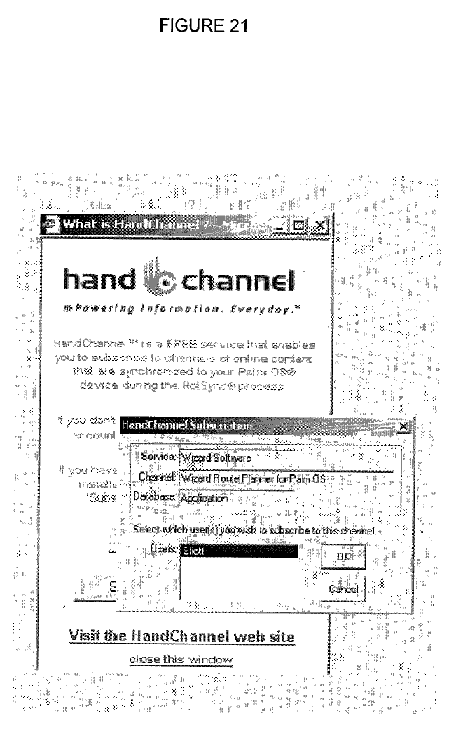

In response to receiving indication that the end user has clicked on the system icon displayed on the confirmation/download page at 1855, the application manager may download the application details and display those details in a confirmation dialogue at 1860 (an example of which is shown in FIG. 21).

Once the system has received confirmation from the end user that they wish to install the software on their handheld the application may be registered with the application manager at 1865.

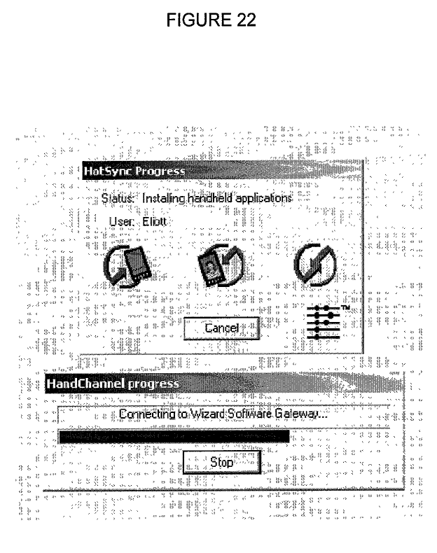

Subsequently, the application manager update operation may be invoked at 1870. The update may be invoked either directly by the end user or through the HotSync® process (an example of the graphical depiction output to the end user during this process is shown in FIG. 22).

Next, the end user may be authenticated at 1875 by checking the user details against information in the channel database to ensure the user is authorized to access the application-type channel.

Following authentication, details of the application-type content channel may then be returned to the application manager at 1880. These details may provide additional information about the software including links to online resources, location of the software package and version information. After the initial install the version information of the application-type content channel may be checked at each update.

If there is a new version of the software package available, the user may be asked if they wish to download and install it (for commercial software this may be subject to further payment if desired by the vendor) at 1885.

Subsequently, the application/software package may be packaged and delivered at 1890. The package may be downloaded and installed to the user's handheld without the end user having to do anything. However, the application vendor may have the option to prompt the user with additional installation information and confirmation at this stage if required.

Next, the purchased application/software/package may be backed up to the end user's PC during a normal handheld device synchronization process at 1895.

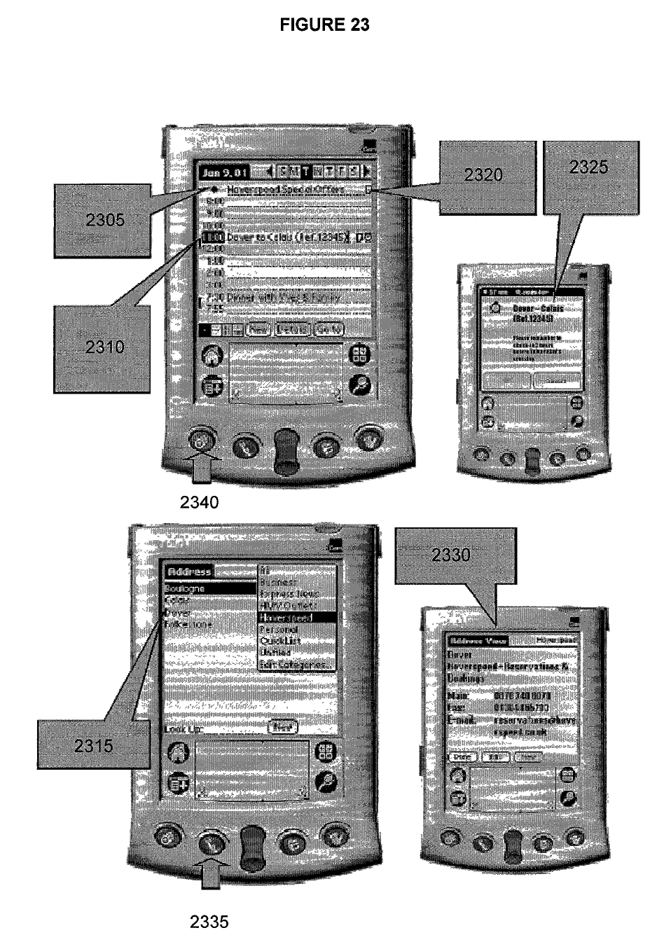

In accordance with the at least the first embodiment of the invention (illustrated in FIG. 23), content delivery and management systems may include such features as centralized diary synchronization, contact information sharing and memo distribution. Additionally, such content delivery and management systems are designed to insert relevant information directly into the main features of any Palm OS® and Windows® CE device.

As shown in FIG. 23, at least this embodiment of the invention may provide for display of un-timed entries 2305 for synchronized information that appears in a handheld's datebook. Additionally, time critical events can be inserted (2310) to match the handheld's centralized administration system. Contact information may also be inserted (2315) into the address feature of the handheld device. Further, a note attachment may be inserted next to each databook entry (2320). This note attachment is simply the note field associated with any standard PIM entry (desktop or handheld). In Palm OS, it may be represented by an icon to the right of the entry in the day view. In Windows CE, it may be represented by an icon (but not necessarily). An alarm function (2325) may also be set to alert timed or untimed diary entries associated with particular content provided via the content delivery and management system. This alarm function and associated displayed data may be associated with a full data entry that contains as much information as is required, e.g., for a flight, booking information, gate, departure time, confirmation number, etc. As shown in FIG. 23, address functions of the handheld may be displayed based on initiation of a particular interface on the handheld, e.g., the address book is associated with a directory icon, the diary function is associated with a schedule icon, etc.

A content delivery and management system designed in accordance with the first embodiment of the invention may include an operating system or is supported by a server that is based in, for example, WindowsNT® and/or UNIX. The operating system for the handheld device, e.g., PDA or web-enabled phone, may be, for example, a PDA Palm OS®. In accordance with at least the first exemplary embodiment of the invention, the content delivery and management system may embed content directly into the operating system of the receiving handheld. A request for information to be inserted into the handheld may be sent to a content source at the point of synchronization; the requested content may then be served directly to the end user by the information source. The content served by the database may be filtered to represent the content in a way that is consistent with the handheld's OS.

An alert to the end user of time critical events (or, for example, daily messages) may take the form of either a timed or un-timed diary entry—with or without an alarm.

Customer service organizations where time specific events are relevant to end users may find such alerts to have increased utility. For example, organizations such as online ticket agencies or transport companies such as airlines or train operators could provide content related to fees, fairs, availability, travel confirmations, etc.

Content providers may use the content system may utilize multiple channels to deliver travel confirmations to end users handheld in English, French German, etc.; each language being associated with a different channel.

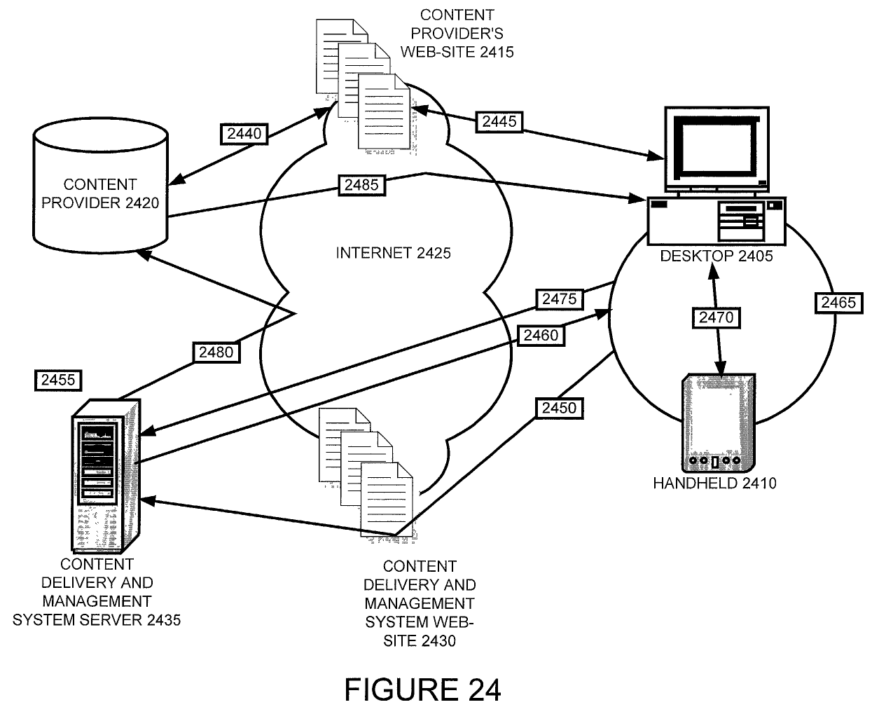

As illustrated in FIG. 24, a system designed in accordance with at least the first embodiment of the invention allows a content provider server to provide content to end users through the content provider's web-site. As shown in FIG. 24, this process may involve interaction of an user's desktop 2405, the user's handheld device 2410, a content provider's web-site 2415, the content provider 2420, the Internet 2425, a content delivery and management system web-site 2430 and the content delivery and management system server(s) 2435. This interaction may described at various stages of the interaction as follows.

At 2440, a content provider 2420 may publish a web-site at 2440 with an embedded content delivery and management system server icon(s) as described above in connection with FIG. 10. When a user interacts with the web-site to select the icon(s) and activate a link to the content delivery and management system web-site 2430 at 2445, the user may receive some information regarding the content delivery and management system and/or be transferred to the content delivery and management system web-site 2430. This web-site 2430 may act as a front end to provide the capability for the user 2405 to interact with the content delivery and management system server(s) 2435 and the software running thereon. The user may then enter information about the type of information he/she wishes to receive. This information may be included in the user's profile, which is stored at the system server(s) 2435 at 2455. Subsequently, the system server(s) 2435 may provide the opportunity to download applications associated with the content delivery and management system to the user's desktop 2405 and/or the handheld device 2410.

Subsequently, when the user initiates a synchronization process at 2470, some indication of the process initiation is transmitted to the content delivery and management system server 2435 at 2475. Subsequently, at 2480, the content delivery and management system server 2435 transfers information associated with the content that the user is interested in receiving to one or more content providers, e.g., content provider 2420, identified by the user's profile. As a result, content provider 2420 may transmit the requested information to the end user's 2420 directly. Subsequently, this requested information may be transferred to the user's handheld device 2410 via the synchronization process.

Therefore, it should be understood that the end user may define what type of information they wish to receive using the content delivery and management system in a user profile. This profile is stored by the system server(s) and/or the desktop and device subscription managers. It should also be appreciated that the end user's information request may be transmitted from the content provider's server once a synchronization process has been initialized. Subsequently, the requested information may be “served” directly by the content provider or via the system's packet engine via one or more servers associated with the system to the end user's PC and then transferred to the handheld via the synchronization process.

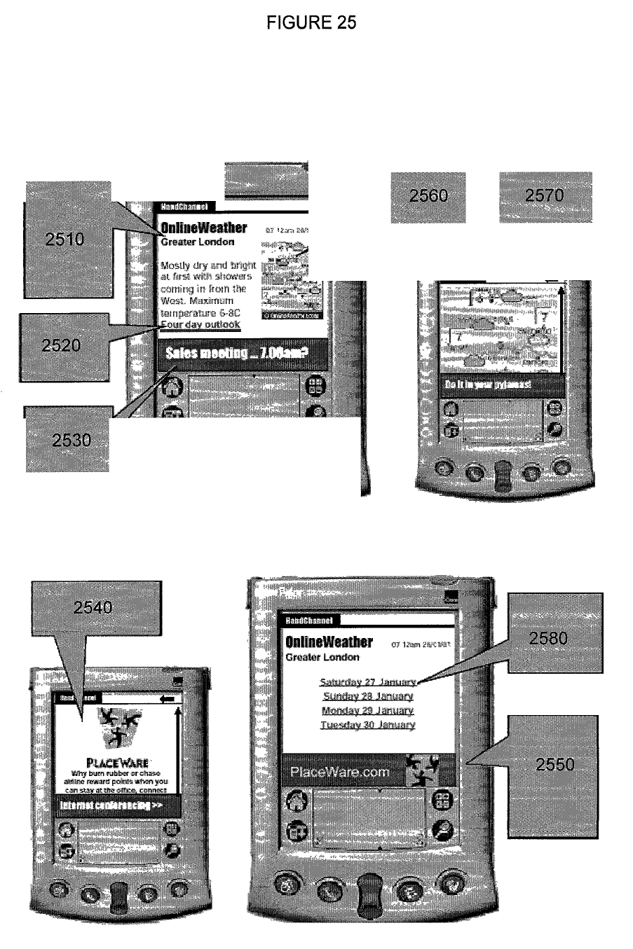

In accordance with at least a second embodiment of the invention (FIG. 25), the content delivery and management system is designed to provide rich content re-purposed from online sources and displayed within a handheld's embedded browser. All features of the first embodiment may be included with the addition of a note launching application, which may allow an end user to access content by clicking on a note icon attached to a timed or un-timed diary entry. The note launching application may be a system extension that intercepts the user action of tapping on a note attachment. It may, for example, read the first few lines of the note to determine if there is a note launching tag present. If there is, the application may launch the specified application with the given parameters. If no tag is found, the application may return control to the PIM application, which may open the text note as normal.

As shown in FIG. 25, at least this embodiment of the invention may provide for display (2510) of personalized information in the content delivery and management system browser, this information having been sent to the handheld device when the handheld device is synchronized with the user's desktop. Additionally, the administrative and management system browser allows full hyperlinking to pre-loaded web-pages (2520). Of particular utility to the content provider may be the optional capability to display (2530) banner advertisements as part of the system browser frameset. Such banner advertisements may provide click-through capability (2540) to an associated advertiser's web-page (potentially pre-loaded during synchronization). Additionally, templates and style guides (2550) may be supplied to advertisers to create advertisements that fit into the content delivery and management system browser banner default size. Color graphics may be re-sized (2560) to fit the administrative and management system browser. The browser may also offer embedded navigation and functionality (2570). All relevant links and content may be downloaded (2580) as part of the synchronization process.

The second embodiment may also include a payment solution system. Payment solutions for payment between the content provider and the end user may be built for content providers (both subscription and micro-payment) and managed through a third party relationship with an e-commerce payment processing entity, e.g., AllCharge Inc.

Thus, at least one embodiment of the invention provides improved utility in that it allows for an effective technique for generating, monitoring and managing revenue in that embedded micro-payment and subscription functionality may be provided. For example, if a content provider wishes to charge end users for every article that was sent to their handheld, or charge a regular subscription, the content provider may utilize the content delivery and management mechanisms provided by the embodiments of the invention in combination with AllCharge, Inc. Likewise, because banner advertisements may be embedded with delivered content using the content delivery and management system designed in accordance with the embodiments of the invention, the content provider may gain further revenue.

Back-end solutions included in at least the second embodiment of the invention may include the development of HTML templates to facilitate easy display of rich content.

In accordance with at least the second embodiment of the invention, the handheld device's embedded browser as a key feature for viewing content. The browser frame-set may have a dedicated area for inserting banner adverts—creating a new opportunity for content providers to offer advertisers another medium for promoting to consumers.

One difference between the first and second embodiments of the invention is the display of content.

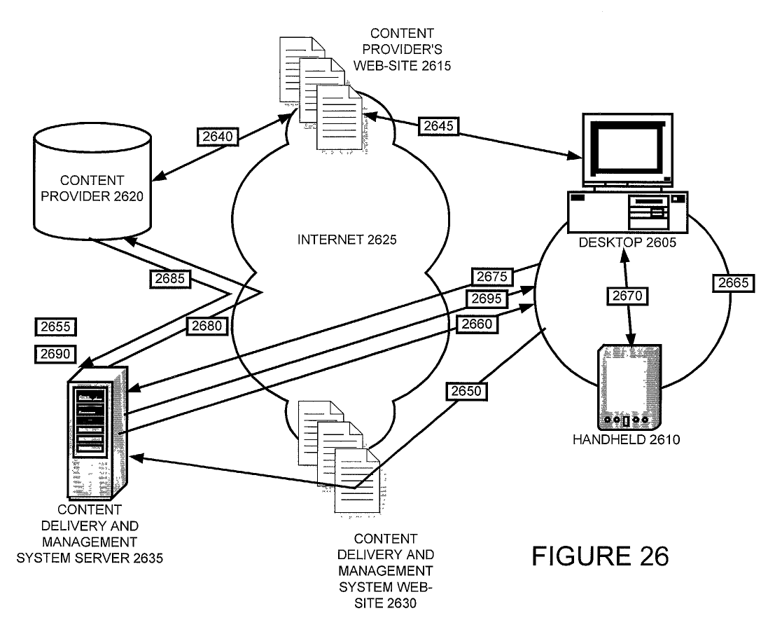

As illustrated in FIG. 26, a system designed in accordance with at least the second embodiment of the invention allows a content provider server to provide content to end users from the content provider's web-site. As shown in FIG. 26, this process may involve interaction of an user's desktop 2605, the user's handheld device 2610, a content provider's web-site 2615, the content provider 2620, the Internet 2625, a content delivery and management system web-site 2630 and the content delivery and management system server(s) 2635. It should be understood that the content delivery and management system server(s) 2635 may support or include the software for the CMS and the packet engine. The interaction between the constituent parts of the system may described at various stages of the interaction as follows.

At 2640, a content provider 2620 may publish a web-site at 2640 with an embedded content delivery and management system server icon(s) as described above in connection with FIG. 10. When a user interacts with the web-site to select the icon(s) and activate a link to the content delivery and management system web-site 2630 at 2645, the user may receive some information regarding the content delivery and management system and/or be transferred to the content delivery and management system web-site 2630. This web-site 2630 may act as a front end to provide the capability for the user 2605 to interact with the content delivery and management system server(s) 2635 and the software running thereon. The user may then enter information about the type of information he/she wishes to receive. This information may be included in the user's profile that is stored at the system server(s) 2635 at 2655. Subsequently, the system server(s) 2635 may provide the opportunity to download applications associated with the content delivery and management system to the user's desktop 2605 and/or the handheld device 2610.

Subsequently, when the user initiates a synchronization process at 2670, some indication of the process initiation is transmitted to the content delivery and management system server 2635 at 2675. Subsequently, at 2680, the content delivery and management system server 2635 transfers information associated with the content that the user is interested in receiving to one or more content providers, e.g., content provider 2620, identified by the user's profile. As a result, content provider 2620 may transmit the requested information through to the delivery and management system server(s) 2655. The packet engine supported by the server(s) 2655 reformats the requested data at 2690 into a format requested by the user, as indicated in the user's profile. This reformatted data is then transmitted to the user's desktop 2605 at 2695. Subsequently, this requested information may be transferred to the user's handheld device 2610 via the synchronization process.

A content delivery and management system designed in accordance with the second embodiment of the invention may include built-in applications or is supported by a server that is based in, for example, WindowsNT® and/or UNIX. The bbuilt-in applications for the handheld device, e.g., PDA or web-enabled phone, may be, for example, a PDA Palm OS®, PocketPC® or EPOC®. In accordance with at least the second exemplary embodiment of the invention, the content delivery and management system may embed content directly into the built-in applications of the receiving handheld. A request for information to be inserted into the handheld may be sent to a content source at the point of synchronization; the requested content may then be served directly to the end user by the information source. The content served by the database may be filtered to represent the content in a way that is consistent with the handheld's built-in applications.

The content delivery and management system also includes a dedicated browser combined with enhanced template features to enable content providers' designers and programmers to build content delivery and management solutions quickly. The dedicated browser frameset may have an option of an embedded banner promotional information frame—which can be used to drive revenues and return on investment. The request for information to be inserted into the handheld's OS may be sent to the content provider at the point of synchronization, the requested content may then be reformatted from the original data source and may then be served directly to the end user via the content provider's server or one or more servers associated with the system. The content served by the database may then be converted to represent the content in a way that is consistent with the PDA screen size and browser capability.

An alert to an end user of time critical events (or, e.g., daily messages) may take the form of either a timed or un-timed diary entry—with or without an alarm, auto e-mail, Short Message Service (SMS) message or personalized ring tone. Payment solutions for payment between the content provider and the end user may be built for content providers (both subscription and micro-payment) and managed through a third party relationship with an e-commerce payment processing entity, e.g., AllCharge Inc.

The second embodiment of the invention may be of particular utility to, for example, content and customer service organizations that are looking to extend the reach of their content into the new handheld medium. Additionally, enterprise customers may find the second embodiment useful if they wish to coordinate mobile and remote workforces.

As shown in FIG. 26, a system designed in accordance with at least the second embodiment of the invention also allows for content access for the end user primarily through a content provider's web-site. As shown in FIG. 26, the end user may define the type of information they wish to receive. This profile is then sent to the system server. Next, the end user's information request is sent to the content provider's server once a HotSync®/ActiveSync® process has been initiated. The requested information may then be served directly by the content provider (via the system reformatting process) or via the packet engine on one or more of the system servers to the end user's PC. Next, the information is then reformatted “on the fly” (data fields and graphics) and then transferred to the end user's handheld via a HotSync® process.

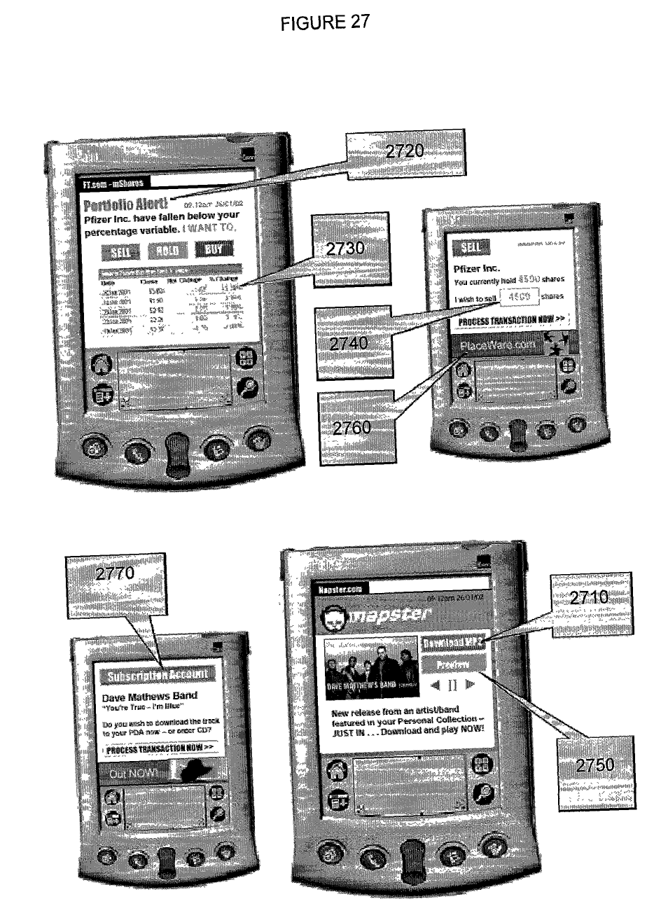

In accordance with at least a third embodiment of the invention (FIG. 27), the content delivery and management system is designed to provide fully developed enhancement of the first and second embodiments. In the third embodiment, requests for information and the display of content may happen in real-time. Rich content is re-purposed on-the-fly to utilize ‘always-on’ wireless connectivity—GPRS and 3G (also known as Global System for Mobile communication or GSM). All features of the first and second embodiments may be included in the third embodiment.

As shown in FIG. 27, at least this embodiment of the invention may provide include a file download system (2710) as in the first and second embodiments of the invention. Additionally, the third embodiment of the invention may utilize wireless “always on” access to deliver time critical information (2720), for example, reminders or news and/or event reports. As a result, also included may be the ability to provide real-time or near real-time accurate data feeds (2730) from database sources to provide data, e.g., stock quotes, scores, et., and real-time or near real-time communication (2740) with the data source for wireless transactions. Additionally, real-time or near real-time broadcast (2750) of content over a broadband network. Of particular utility to the content provider may be the optional capability to display (2760) advertisements enhanced with Java programming. Additionally, the system may allow for a payment solution system such as that described above in relation to the second embodiment of the invention.

In accordance with at least the third embodiment of the invention, a server-based personalization engine may be utilized to analyze each individual end user's habits and preferences—this may generate increased opportunities for accurately cross-marketing other relevant products and services.

One difference between the second and third embodiments of the invention is that transfer of data from the source to the handheld device is shifted from a wired synchronization process to a wireless “always on” connectivity. As a result, the third embodiment, utilizing wireless “always on” connectivity, may deliver immediate two way communication between the end user device and content source.

Content delivery and management systems designed in accordance with at least the third embodiment of the invention may have all of the features provided by the first and second embodiments of the invention. However, the third embodiment also may be based on a major shift in infrastructure technology to provide the end user with high speed (bandwidth) wireless access to information from their handheld. The result of this shift means that wireless ‘online’ interaction can take place whether it is two-way transactional (e.g., share dealing, personal finance) or one-way, e.g., simply requesting information from a source, although this time not requiring the PC to be a component of the process.

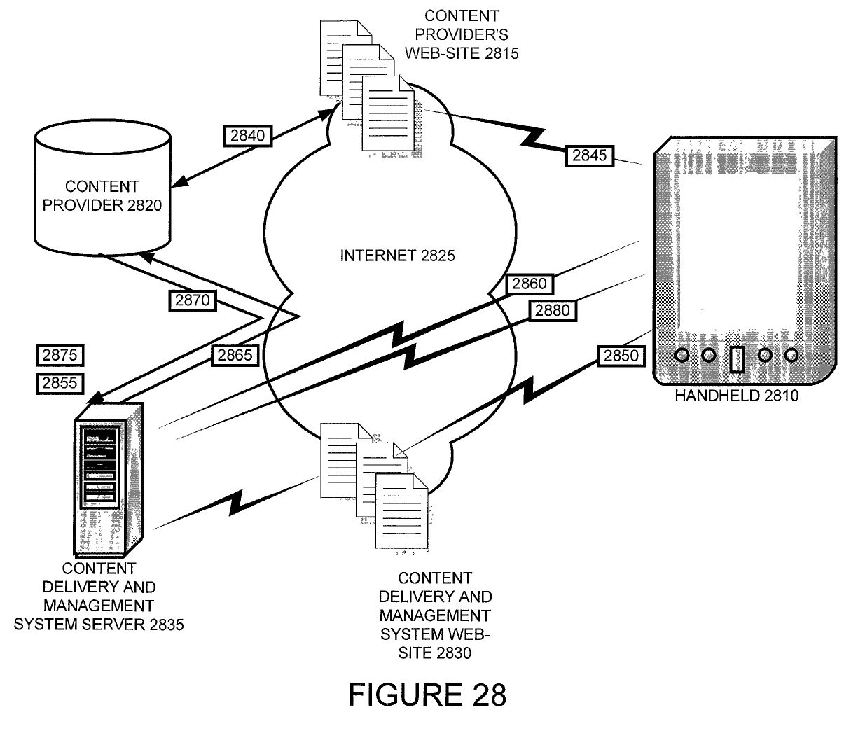

As illustrated in FIG. 28, a system designed in accordance with at least the third embodiment of the invention allows a content provider server to provide content to end users from the content provider's web-site. As shown in FIG. 28, this process may involve interaction of a user's handheld device 2810, a content provider's web-site 2815, the content provider 2820, the Internet 2825, a content delivery and management system web-site 2830 and the content delivery and management system server(s) 2835. It should be understood that the content delivery and management system server(s) 2835 may support or include the software for the CMS and the packet engine. The interaction between the constituent parts of the system may be described at various stages of the interaction as follows.

At 2840, a content provider 2820 may publish a web-site at 2840 with an embedded content delivery and management system server icon(s) as described above in connection with FIG. 10. When a user interacts with the web-site to select the icon(s) and activate a link to the content delivery and management system web-site 2830 at 2845, the user may receive some information regarding the content delivery and management system and/or be transferred to the content delivery and management system web-site 2830. This web-site 2830 may act as a front end to provide the capability for the user 2805 to interact with the content delivery and management system server(s) 2835 and the software running thereon. The user may then enter information about the type of information he/she wishes to receive. This information may be included in the user's profile, which is stored at the system server(s) 2835 at 2855. Subsequently, the system server(s) 2835 may provide the opportunity to download applications associated with the content delivery and management system to the user's handheld device 2810.

Subsequently, when the user's handheld may communicate a request for content to the content delivery and management system server 2835 at 2860. Subsequently, at 2865, the content delivery and management system server 2835 transfers, at 2865, information associated with the content that the user is interested in receiving to one or more content providers, e.g., content provider 2820, identified by the user's profile. As a result, the content provider 2820 may transmit the requested information at 2870 to the delivery and management system server(s) 2855. The packet engine supported by the server(s) 2855 reformats the requested data at 2875 into a format requested by the user, as indicated in the user's profile. This reformatted data is then transmitted to the user's handheld device 2810 at 2880.

A content delivery and management system designed in accordance with the third embodiment of the invention may include an operating system or is supported by a server that is based in, for example, WindowsNT® and/or UNIX. The operating system for the handheld device, e.g., PDA or web-enabled phone, may be, for example, a PDA Palm OS®, PocketPC® or EPOC®. In accordance with at least one implementation of the third exemplary embodiment of the invention, the content delivery and management system may embed content directly into the native applications of the receiving handheld. A request for information to be inserted into the handheld may be sent to a content source at the point of synchronization with a user's desktop as well. The content served by the database may be filtered to represent the content in a way that is consistent with the handheld's OS. The requested content may then be served directly to the end user by the content source or via one or more servers associated with the system.

As explained above, at least one embodiment of the invention, e.g., the second and third embodiments, may include may provide a content delivery and management system that includes a dedicated browser. In accordance with at least one embodiment of the invention, this dedicated browser may be combined with enhanced template features to enable content providers' designers and programmers to build content delivery and management solutions quickly. The dedicated browser frameset may have an option of an embedded banner promotional information frame (e.g., at 2530 in FIG. 25), which can be used to drive revenues and return on investment.

It should be understood that the user's request for information may be sent to the content provider with information indicating the requested format or version of that content. Based on this information, the content may then be reformatted from the original data source and served directly to the end user by the content provider's server. In the case where the requested data is deliver to the user's desktop, software stored and running on the desktop may reformat the content to represent the content in a way that is consistent with the user's handheld, e.g., the PDA screen size and browser capability.

The third embodiment of the invention may be of particular utility to, for example, content and customer service organizations that are looking to extend the reach of their content into the new handheld medium. Additionally, enterprise customers may find the third embodiment useful if they wish to coordinate mobile and remote workforces. includes all or some of the features provided by a handheld device may utilize these services as well. Additionally, the user's device that provides access to the content delivery and management system services may include a PC, PDA, web-enabled phone or any device that provides any or all of the features associated with these devices. Moreover, such a device may also include the capability or functionality allowing a user to activate/deactivate certain functions or services verbally. Therefore, it should be appreciated that any such device may include voice recognition and activation technology and capability.

Utility of the exemplary embodiments as it particularly pertains to delivery and management of content such as software applications will now be provided.

In accordance with at least the first embodiment of the invention, the system components may support delivery of update notification and promotional information to the user's calendar on their desktop or handheld.

In accordance with at least the first embodiment of the invention, a content delivery and management system is provided that enables transfer, installation and management of software applications. The content delivery and management system may be able to deliver and install applications via a one-click web icon interface and provides the user with an intuitive means of managing those applications both on their device and their desktop computer. The application files are managed using channels with the user subscribing to a particular application's channel. Once subscribed to the appropriate channel the user can be notified of product updates and can immediately install the latest version (if required). The user can be notified during the normal desktop synchronization process and/or through untimed entries placed directly into their calendar. Calendar entries can be used as alerts to updated software, new software or other promotional messages, and can be accompanied by rich web content. Applications may be made available through an Application Aggregator (AA) or developer service through channels with the user subscribing to those that interest them.

The main method for delivery of content may be during the HotSync®/ActiveSync® process and so integrates tightly with the user's routine usage of their handheld device. However, the user may also be able to perform updates directly from their handheld device via a wireless or wired Internet connection.

In order to use the system, the user needs to install the system software on their desktop computer and/or handheld device. Once the software is installed the user may subscribe to an available channel by clicking on the system-specific icon on an enabled web page. This system-specific icon may be linked to a small subscription file, which may include all the information the user software requires to connect to the associated channel. The

In accordance with at least the third embodiment of the invention, a group synchronization feature may be incorporated, which may be used in conjunction with, e.g., the Palm® Computing Platform and enable Palm Operating System® (Palm OS®) compatible device users to share calendars, contacts, tasks and memos among the members of a workgroup while retaining individual privacy—peer-to-peer. This group synchronization feature enables users to share files and information across a Local Area Network (LAN) or via a high-speed, short-distance wireless protocol, e.g., Bluetooth, using a peer-to-peer (P2P) solution. Within a wireless environment, the incorporation of this feature may allow for sharing information between users and helping to ensure that the exchange of programs or premium content can be tracked and appropriately charged to an end user.

The group synchronization feature may allow for insertion of timed or un-timed entries (alerts) into a date book such as, for example, that provided by the date book function associated with Palm OS®. Additionally, the feature may allow for insertion of contact information into an address book such as, for example, the address function provided by Palm OS®. Further, the group synchronization feature may allow for the insertion of documents into a memorandum provided by, for example, the Memo function (Palm OS®) and may also support the ability to load third party applications without the need for a full install process. Moreover, the group synchronization feature may enable synchronization of all data with a PC PIM, for example, MS Outlook®), Lotus Notes®g, etc.

The group synchronization feature may also provide, utilize or work in conjunction with a PC-based subscription manager that may support delivery of content through, for example, Secure Sockets Layer (SSL) technology, to support authentication for user access to private channels.

It should be understood that all the group synchronization features may be implemented on any HANDHELD including, but without limitation, any model of Palm Pilot®, PocketPC® and EPOC® and their associated software.

While this invention has been described in conjunction with the specific embodiments outlines above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of the invention.

For example, although the embodiments of the invention have referred generally to handheld devices, it should be understood that web-enabled phones may also utilize the services provided by the content delivery and management systems. Moreover, a device that subscription file type may be setup as a registered Multipurpose Internet Mail Extensions (MIME) type during installation so it is downloaded and opened in one action.

During the next HotSync®, the user software may fetch both the subscribed channel data and an up to date list of all channels available from the application content provider(s). The user then may subscribe to further channels direct from the subscription manager application without having to visit the associated web page. The subscription manager may also give a user the opportunity to deactivate or remove subscriptions.

During system operation, a content developer may administer details of the applications it wants to make available via an Application Aggregator (AA) site. A subset of these details may be posted to one or more servers associated with the system and a channel for delivering each piece of content, e.g., application, is created. Additional parameters may be required from the developer depending on their particular application. The AA may also have the opportunity to set up templates for simple text notification channels.

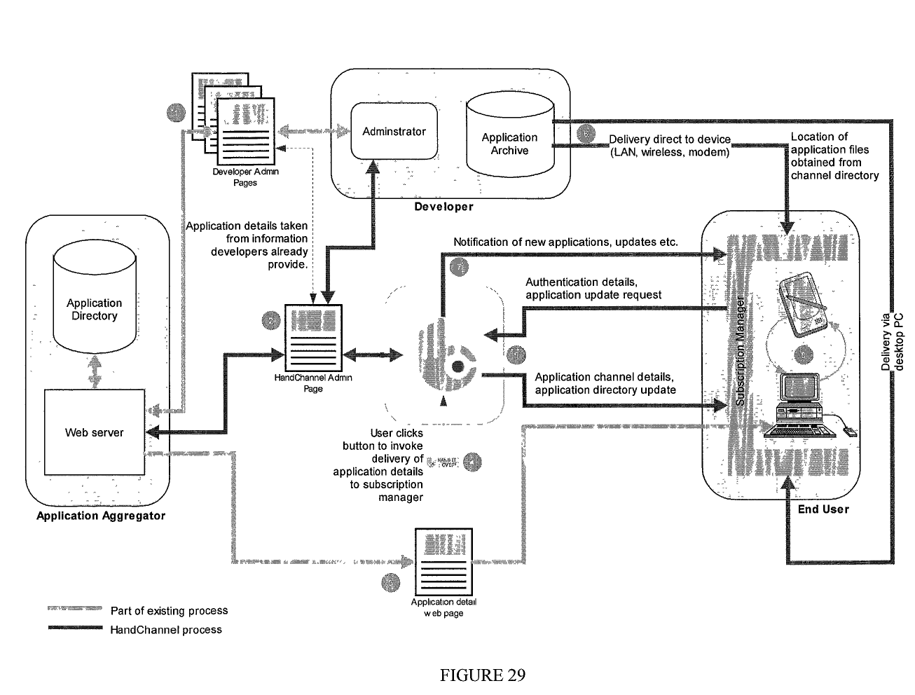

Users may visit the AA site, either from their desktop or from their handheld device, to look for software (See FIG. 29). At the AA site, they may be presented with a system-specific icon on the application detail page. Following indication that the user has excited (e.g., clicked on) the system-specific icon, if the user is already registered with the system then the user simply may have to confirm their action and a small file containing the details of the application they are interested in will be downloaded to the subscription manager. If the user does not already have a user account then they may need to go through a simple registration and installation process first.

The update process may be invoked either explicitly by the user through the subscription manager or implicitly through normal HotSync®/ActiveSync® operation. User details may be sent to one or more servers associated with the system for authentication along with information about the applications that the user is interested in. After authentication has completed successfully, full details about each application channel may be returned to the subscription manager including an updated channel directory.

Using application channel information obtained from the at least one server associated with the system, the subscription manager may request application files directly from the application developer's server.

Promotional messages, notification of updates, etc. can be pushed to the end user and appear as bulleted, untimed entries in their calendar on their handheld device. After the HotSync®/ActiveSync® process these messages may appear in their desktop PIM also. During the normal HotSync®/ActiveSync® process, the application files may be transferred from the desktop to the handheld device and/or backed up from the device onto the desktop.

Use of the system and methods according to at least the first embodiment of the invention may require a main installation package and a device-specific installation package. The main installation package may incorporate both the desktop and device components. This package may need to be available for executing directly from the Internet in addition to a standalone, downloadable package. The main installation package may be implemented using or compatible with various technologies, e.g., InstallShield or other products used by software developers to package software so that users can install and uninstall it easily and safely. The device-specific installation package may include only device-specific components. This device-specific installation may be invoked from a desktop computer or from the handheld device. The normal process of subscription through exciting icons in web pages is possible but not desired on a handheld device; therefore pre-installed system-specific services may be required as part of “handheld device only” installations.

The subscription manager for the handheld device may offer similar functionality to the desktop version of the subscription manager including ability to act as a conduit between at least one server associated with the system and the local applications and databases during a mobile channel update. The subscription manager for the handheld device may be implemented using or compatible with various technologies including, e.g., Palm® SDK, NetLib, InetLib, CodeWarrior, MFC, Wininet, HTTP, SSL, etc.

For application delivery and management, the note launching application may notify users of updates, bug fixes etc. via an untimed entry in the device calendar. This calendar entry may contain plain text information, but could also directly link to either an online resource (for use on the desktop computer) or an application or database on the device itself. On a Pocket PC platform, it may be possible to do this using hypertext links within calendar note entries in MS Outlook®, which may be formatted appropriately by at least one server associated with the system. However, on the Palm® OS platform, there may not be built in functionality that allows the user to link seamlessly between the calendar and third party information. Thus for Palm® OS devices, a component may be required to directly launch applications and databases when a user excites the note icon next to the untimed calendar entry inserted by a server associated with the system. The note launching application may be implemented using or compatible with various technologies including MS Pocket Outlook®, X-Master Extensions, etc.

The user gateway may act as an interface between software on the user's desktop or handheld device and the server; it may provide user authentication, channel subscription information and updates to channel directories. The user gateway may be implemented using or compatible with various technologies including, e.g., Internet Information Server (IIS), Structured Query Language (SQL) Server, MFC, Internet Server Application Protocol Interface (ISAPI), Open DataBase Connectivity (ODBC), SSL, etc.

The packet engine may handle delivery of channel data (e.g., applications, databases, and notifications) and the appropriate formatting and compression required for the requesting device. The packet engine may be implemented using or compatible with various technologies including, e.g., MFC, Zip, MS cabinet files, etc.

The CMS may be used to set up and administer channels in addition to managing notification messages. The CMS may be implemented using or compatible with various technologies including, e.g., IIS, SQL Server, JRun, Java Server Page (JSP), Java DataBase Connectivity (JDBC).

A channel administrator module (see FIG. 29) may provide a web-based interface for setting up and administering channels. This may either be accessed directly or information may be posted to it from the AA's web server. A notification manager may provide a web-based interface that may be used to manage the content of notification messages in addition to promotional ones and to specify with which channels to associate each message. A data access component may be provided that enables the AA to connect to a database on an application developer's web-site and map data fields to a notification template for messages whose content is changing regularly and/or is already stored in database form.

In accordance with at least the second embodiment of the invention, the systems and methods enable users to manage the applications and files they carry on their device. In accordance with at least the second embodiment of the invention, the content delivery and management system may build upon the system provided in the first embodiment. Using the mechanisms and processes already in place, additional components may provide Personal Configuration Management (PCM) functionality for the end user. This PCM functionality may enable the user to swap applications and their associated files in and out of their handheld device or desktop for the purpose of releasing limited storage resources, backup and restore.

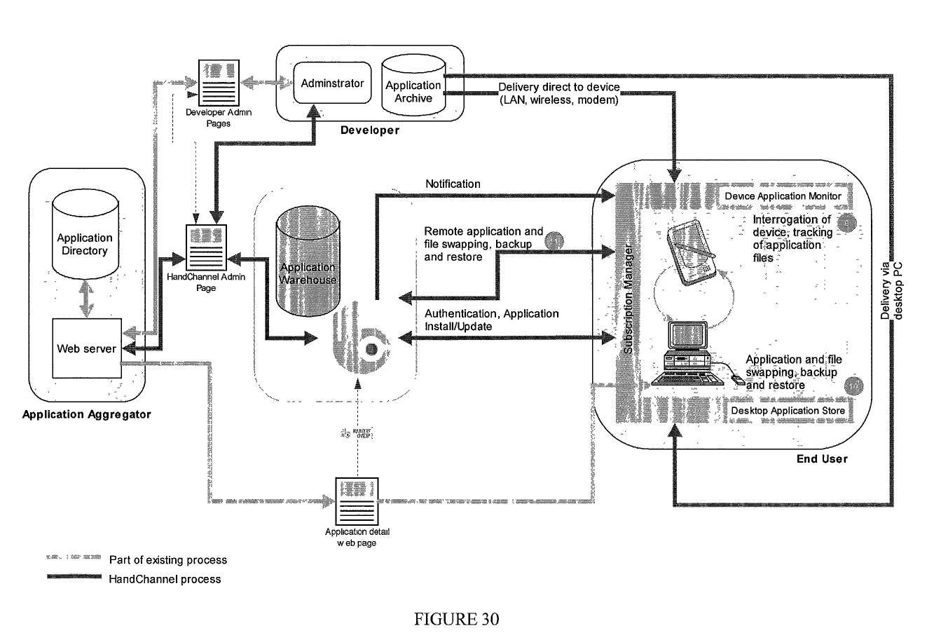

The main method for movement of applications and files may be during the HotSync®/ActiveSync® process (see FIG. 30) and so integrates tightly with the user's routine usage of their device(s). However, the user may also be able to perform PCM operations directly from their handheld device via a wireless or wired Internet connection. In order to use the system, the user may need to install the system-specific software (e.g., subscription manager, etc.), complete with the PCM components, on their desktop computer and/or device. Once the software is installed the user may choose those applications and files currently on their device that they wish to have managed by the content delivery and management system. A channel may be created for each application and file; during the next HotSync®/ActiveSync®, the selected files may be backed up (if required) to the desktop or server. The user may have the choice of using a desktop or server based application store.

With reference to FIG. 30, the device application monitor may initially interrogate the user's device and output the option to mark those applications and files that should be managed by the content delivery and management system. Once this is done, the monitor may track the installation of new applications and files and either automatically create channels for their management or prompts the user to confirm that they should be managed by system.

In a PC-based package, applications and files may be kept in the desktop application store where they, and their associated files, can be swapped in and out of the device depending on actions the user specifies in either the PC or device subscription manager.

In the subscription-based package, applications and files may be kept in the application warehouse on one or more servers associated with the system from where they can be swapped in and out of the device remotely. The application store manager component may manage the check-in/check-out of applications and files to the desktop repository.

In addition to the functionality provided by the first embodiment, the user gateway may control licensing of the PCM facilities, to ensure that the user is being charged correctly for the use they are making of the service. The CMS may be used to set up and administer channels, manage notification messages and maintain user PCM profiles. The application warehouse manager may be configured to control the remote check-in/check-out of applications and files for those users who have chosen the hosted service.

In accordance with at least the third embodiment of the invention, the systems and methods are extended to offer software licensing capability, which may remove the need for the user to be involved in entering lengthy serial numbers to register their software. The system also may store these serial numbers in the event that the user has to re-install their software at a later date. Thus, the user may be saved from having to hunt down the original electronic mail containing the serial number.

One side effect of this functionality is that the system can check that the user has only installed the software on one device (or as many as they have licenses for). To achieve this control of third party applications, the system administrators may provide developers with an API that may be used in their applications through which the system can check licensing details. As a result, the way that the developers generate their serial codes and protect their software remains known only to them.

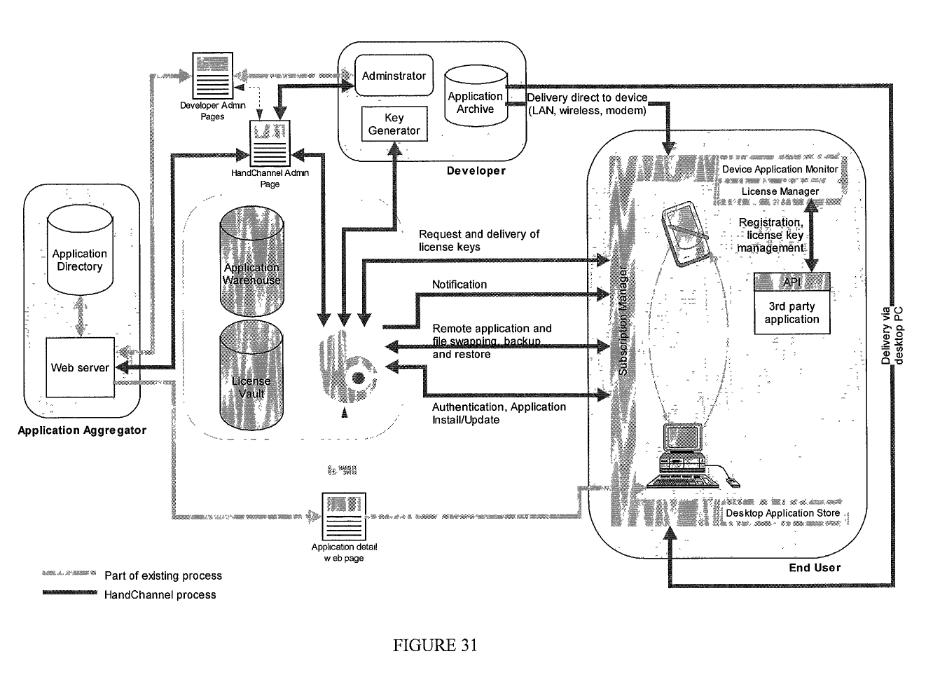

As illustrated in FIG. 31, additional functionality may be associated with or provided by at least the third embodiment of the invention in association with delivery and management of content that includes applications.

TABLE 1

| MEMO | | | | |
|---|---|---|---|---|
| Field | Name | Description | Format | Example |
| 1 | Creator | Identifies for which | Constant | memo |
| | ID | database on the Palm | | |
| | | device the data is | | |
| | | formatted. | | |
| 2 | File | Version of data format | Constant | 1 |
| | Version | used to prepare this data. | | |
| 3 | Memo | Memo content | String (4096) | |
| 4 | Private | Private flag | Boolean (0\|1) | 0 |

TABLE 2
CALENDAR

| Field | Name | Description | Format | Example |
|---|---|---|---|---|
| 1 | Creator ID | Identifies for which | Constant | date |
| | | database on the | | |
| | | Palm device the data | | |
| | | is intended. | | |
| 2 | File Version | Version of data | Constant | 3 |
| | | format used to | | |
| | | package this data. | | |
| 3 | Start Date | Date that data item | dd/mm/yyyy | 01/01/2001 |
| | | applies. | | |
| 4 | Start Time | Can be left blank | hh:mm:ss | 14:15:00 |
| | | for an untimed event | | |
| | | (bulleted item). | | |
| 5 | End Date | Can be left blank for | dd/mm/yyyy | |
| | | untimed event. | | |
| 6 | End Time | Can be left blank for | hh:mm:ss | |
| | | untimed event. | | |
| 7 | Description | This is what appears | String(25) | Your Weather: |
| | | in the Day View of | | SW England |
| | | the user's calendar. | | |
| | | Should be no longer | | |
| | | than 25 characters to | | |
| | | avoid screen clutter. | | |
| 8 | Note | This is the main | String(4096) | Your regional |
| | | body of information | | forecast for |
| | | that the user can | | South West |
| | | access by tapping | | England, |
| | | the icon attached | | brought |
| | | to the calendar | | to you by . . . |
| | | entry. | | |
| 9 | Untimed | Set this flag for | Boolean(0\|1) | 0 |
| | | untimed (bulleted) | | |
| | | day view items. | | |
| 10 | Private | Set this flag to make | Boolean(0\|1) | 0 |
| | | the record private on | | |
| | | the user's device. | | |
| | | Private records on | | |
| | | the device can only | | |
| | | be accessed using a | | |
| | | password preset by | | |
| | | the user. | | |
| 11 | Alarm Set | Set this flag to add | | 0 |
| | | an alarm to a timed | | |
| | | item. | | |
| 12 | Alarm Adv. | Amount of time | Integer | 5 |
| | Time | before timed item | (0-99) | |
| | | occurs that user | | |
| | | should be reminded. | | |
| 13 | Alarm Adv. | Unit to use for | Enum | 0 |
| | Unit | advance reminder. | (Minutes = | |
| | | | 0; Hours = | |
| | | | 1; Days = 2) | |
| 14 | Reserved | | | |
| 15 | Reserved | | | |
| 16 | Reserved | | | |
| 17 | Reserved | | | |
| 18 | Reserved | | | |

TABLE 3
CONTACTS

| Field | Name | Description | Format | Example |
|---|---|---|---|---|
| 1 | Creator ID | Identifies for which | Constant | addr |
| | | database on the | | |
| | | Palm device the | | |
| | | data isformatted. | | |
| 2 | File Version | Version of data | Constant | 1 |
| | | format used to | | |
| | | prepare this data. | | |
| 3 | Last Name | | String | Smith |
| 4 | First Name | | String | John |
| 5 | Title | | String | Sales Manager |
| 6 | Company | | String | Acme Telesales |
| 7 | Phone1LabelID | Label ID for | Integer | 5 |
| | | first contact | (0-7) | |
| | | information. Labels | | |
| | | are Work (0), Home | | |
| | | (1), Fax (2), | | |
| | | Other (3), E-mail | | |
| | | (4), Main (5), | | |
| | | Pager (6), Mobile | | |
| | | (7) | | |
| 8 | Phone1 | First contact | String | 020 3435 2342 |
| | | information data | | |
| 9 | Phone2LabelID | | Integer | |
| | | | (0-7) | |
| 10 | Phone2 | | String | |
| 11 | Phone2LabelID | | Integer | |
| | | | (0-7) | |
| 12 | Phone3 | | String | |
| 13 | Phone4LabelID | | Integer | |
| | | | (0-7) | |
| 14 | Phone4 | | String | |
| 15 | Phone5LabelID | | Integer | |
| | | | (0-7) | |
| 16 | Phone5 | | String | |
| 17 | Address | | String | |
| 18 | City | | String | |
| 19 | State/County | | String | |
| 20 | Zip/Postcode | | String | |
| 21 | Country | | String | |
| 22 | Note | | String | |
| | | | (4096) | |
| 23 | Private | Set this flag | Boolean | 0 |
| | | to make record | (0\|1) | |
| | | private on user's | | |
| | | Palm. | | |
| 24 | Reserved | | | |
| 25 | Reserved | | | |
| 26 | Reserved | | | |
| 27 | Reserved | | | |
| 28 | DisplayLabel- | ID of contact | Integer | 1 |
| | ID | information to be | (1-5) | |
| | | displayed in main | | |
| | | contact list. | | |

What is claimed:

1. A content delivery and management system, wherein the content is provided by a content provider over a network based on at least one request from an end user received by the system, the system comprising:
a content provider-specific component configured to transmit content published by the content provider over a network via at least one content channel;
a system-specific component configured to interact with the content provider-specific component to transmit at least one content request from the end user to the content provider-specific component; and
a web management component associated with at least one user device and configured to transmit the at least one content request to the system-specific component and receive requested content from the content provider-specific component via the at least one channel over the network.

2. The system of claim 1, wherein the content provider-specific component is configured to support transmission of content to the web management component and wherein the web management component is configured to output an alert to an end user that newly available content.

3. The system of claim 1, wherein the content is dynamic.

4. The system of claim 1, wherein the network is a wireless network.

5. The system of claim 1, wherein the web management component is resident on at least one end user device and is configured to support display of received content in at least one of the end user device's PIMs.

6. The system of claim 5, wherein the web management component is configured to enable display of content including chronological data in a calendar-related PIM.

7. The system of claim 5, wherein the web management component is configured to display content including dynamic travel data in an address book-related PIM.

8. The system of claim 1, wherein content associated with time specific events is associated with an expiration date that indicates when that content may be discarded.

9. The system of claim 1, wherein the system is configured to support delivery of content related to at least one of personalized television guide, adult entertainment, ticketing customer service, online gaming, electronic books and publications, a news-feed service, music download and replay, television previews and scheduling, recruitment and contracting, listings and entertainment, betting and gambling, personal investment portfolios and entertainment previews.

10. The system of claim 1, wherein the content provider-specific component of the system comprises:
a content management subsystem configured to support initialization of the at least one channel by supporting templates for mapping data fields and content;
at least one packet engine configured to format and compress content into a content package; and
a user gateway configured to administer registration, authentication and delivery of channel directories.

11. The system of claim 10, wherein the content management subsystem is a web-based application.

12. The system of claim 10, wherein the data content provider-specific component further includes at least one channel specific database and the content management subsystem is configured to receive configuration data based on its requests, set up channels and format content from the content provider and provide details about published channels to the at least one channel specific database.

13. The system of claim 12, wherein the at least one channel specific database is coupled to and provides information related to channel lists and subscription details to the web management subsystem.

14. The system of claim 10, wherein the content management subsystem is configured to provide formatted content to the packet engine, which is figured to dynamically format and compress content associated with the at least one channel.

15. The system of claim 1, wherein the at least one channel is associated with a specific piece of content that the content provider makes available via the delivery and management system.

16. The system of claim 1, wherein the system-specific component and the content provider-specific component are configured to cooperate to support display of a user interface to the content provider, the user interface allowing entry of data used to build the at least one channel.

17. The system of claim 16, wherein the user interface is a graphical user interface that includes at least one of a channel code field, a channel name field, a description field, a route universal resource locator field, a content type field, content category field, a privacy indicator field, a static indicator field, an express indicator field and an expiry date field.

18. The system of claim 1, wherein the system-specific component and the web management subsystem component are configured to cooperate to support output of a subscription management interface to an end user, the subscription management interface including at least one of a list of subscribed to channels, an indication of a PIM associated with each subscribed to channel and a section associated with subscribing to additional channels, the section including a field where the end user may enter a code associated with a particular channel to add that channel to their subscription or a list of channels associated with a particular service from which the user may select from.

19. The system of claim 1, wherein the at least one channel is associated with a support group of channels, which includes at least one channel that supplies supporting content for the at least one channel.

20. The system of claim 1, wherein the web management subsystem is configured to receive input from an end user regarding at least one content request of the end user.

21. The system of claim 1, wherein the web management subsystem coordinates receipt of requested content from the content provider over the network.

22. The system of claim 1, wherein the web management subsystem formulates the content requests based on information received from an end user.

23. The system of claim 22, wherein the web management subsystem transmits the content requests over the network to the system-specific component.

24. The system of claim 23, wherein the system-specific component is configured to analyze the content requests and generate and transmit content request and formatting information to the content provider-specific component.

25. The system of claim 1, wherein the web management subsystem includes a mobile device subscription manager and a desktop subscription manager, each of which being configured to enable an end user to manage received content.

26. The system of claim 25, wherein the web management subsystem further includes at least one data structure configured to store user-specific data.

27. The system of claim 1, wherein the web management subsystem includes a note launching application that enables a specific application to be launched from a note icon attached to a diary or to-do list entry associated with an alert in a diary of an end user's device associated with the web management subsystem as a prompt to view received content.

28. A content delivery and management method comprising:
receiving a content request from an end user;
analyzing the content request to determine the requested content and a requested format for the requested content; and
transmitting information indicating the requested content and the requested format for the requested content to a content provider associated with the requested content,
wherein, the method enables transmission of content over a network via at least one content channel to the end user who requested the content.

29. The method of claim 28, wherein the network is a wireless network.

30. The method of claim 28, further comprising formatting the content for delivery through a content delivery and management system included in the content provider-specific component;

31. The method of claim 30, wherein the formatting content includes utilizing the content management subsystem to set up field mappings by locating and connecting to an open database connectivity content source and mapping available data fields to appropriate placeholders in a template for each channel.

32. The method of claim 31, wherein the method further comprises dynamically formatting data, using a at least one packet engine of the content delivery and management system, from a content provider's data source as channel content is requested by the end user.

33. The method of claim 31, further comprising receiving user-specific information from the end user during a user registration process in which the information is received from the end user via a user interface associated with a web-site associated with a content delivery and management system.

34. The method of claim 28, further comprising:
receiving transaction specific information after the end user has made an associated electronic-commerce transaction;
outputting content enabling the display of a confirmation page to an end user browser, the confirmation page including a system icon with transaction identification data included as a hidden parameter;
extracting details associated with the end user from the transaction specific information; and
associating the end user with a channel used to deliver content associated with the electronic-commerce transaction.

35. The method of claim 34, further comprising:
receiving indication of interaction of the end user with the system icon on the confirmation page; and
receiving indication of a request of an end user to deliver the information associated with the electronic-commerce transaction to the end user.

36. The method of claim 35, further comprising:
packaging the requested information;
transmitting the packaged information to the end user; and
integrating the transmitted information into at least one device associated with the end user.
